(19) United States
(12) Patent Application Publication
(10) Pub. No.: US 2002/0128938 A1
(43) Pub. Date: Sep. 12, 2002

(54) Generalized market measurement system

(76) Inventors: Richard Ronald Schofield, Boston, MA (US); Walter Philipp Hertz JR., North Reading, MA (US); Bernard Michael Gunther, Lexington, MA (US)

Correspondence Address: Brown Raysman Millstein,, Felder & Steiner LLP, 900 Third Avenue, New York, NY, 10022, US

(21) Appl. No.: 10/014,843

(22) Filed: Nov. 13, 2001

Related U.S. Application Data
(60) Provisional application No. 60/247,426, filed on Nov. 12, 2000.
(60) Provisional application No. 60/248,126, filed on Nov. 13, 2000.

(51) Int. Cl. G06F 17/60

(52) U.S. Cl. 705/35

(57) ABSTRACT

A computer implemented method for processing data representing transactions involving a plurality of commodities and one or more suppliers for each of the plurality of commodities. Data is received that represents a transaction involving one of the plurality of commodities, the data having a format and including a price, a quantity, two or more characteristics of the commodity involved in the transaction, and the identity of the supplier of the commodity involved in the transaction. The data is translated from its received format into an internal format that allows for the price, the quantity, each of the commodity characteristics, and the supplier identity of the data representing the transaction to be directly accessed. Calculations may be performed on the translated data to produce reports based on price, quantity, one or more characteristics of the specification for a commodity, and in relation to internal and/or external benchmarks.

### CROSS-REFERENCE TO RELATED APPLICATIONS

This application claims priority from U.S. Provisional Application No. 60/247,426, filed on Nov. 12, 2000, and U.S. Provisional Application No. 60/248,126, filed on Nov. 13, 2000, both of which are hereby incorporated by reference into this application.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to the field of spending analysis. More particularly, the present invention relates to a computerized system and method for analyzing the spending performed by an entity for goods and services.

The following are terms used in the art:

A “Buying Entity” is any identifiable purchaser of any good or service, such as an individual, corporation, partnership, or other association.

“Expected Price” is the price that a Buying Entity expects to pay for a transaction, and is generally, but not exclusively, disclosed on a purchase order, contract, or written letter of authorization between a Buying Entity and a supplier to that entity.

“Expected Quantity” is the quantity that a Buying Entity expects to procure in connection with a purchase order, contract, or written letter of authorization between a Buying Entity and a supplier to that entity. If Expected Price is defined, then Expected Quantity need not be defined as many agreements between buyers and sellers simply specify the price at which transactions will take place in the future. Less commonly, the reverse can also be true as some purchase orders, contracts, and written letters of authorization may specify Expected Quantity but be silent as to Expected Price. (Consider, for example, raw materials in supply constrained markets where the Buying Entity's objective is to secure steady access to otherwise scarce resources to be delivered in the future at the then prevailing market price.)

“Contract” is any arrangement between a Buying Entity and a supplier, for any defined or undefined period of time, detailing either an Expected Price, an Expected Quantity, or both for a specification as defined below. Contracts can take the form of purchase orders and written letters of authorization in addition to “formal” contracts.

Buying Entities, such as large corporations, routinely purchase goods and services in the course of doing business. To determine whether such purchases are meeting the projected needs of the Buying Entity, an analysis of the purchases is performed. For instance, an executive at Corporation X may wish to know how much Corporation X spent in the past year for Spending Category Y and how that amount compared with the projected budget for Spending Category Y.

An example will clarify the situation. Walk into the administrative offices of any large Buying Entity that procures, for example, security guards, and ask the procurement manager the following question: “How are your aggregate expenditures on security guards running with respect to budget, year to date?” Modern accounts payable, general ledger, and budgeting systems working in conjunction can efficiently solve this problem. Our competent procurement manager will quickly give you a reply: “x% above (or y% below) budget.”

However, if we ask the follow-up question—“Why?”, then art abandons the procurement manager. This is because current systems do not have a means to record enough information about purchases other than the amounts paid and the Cost Centers inside the Buying Entity whose budgets are charged for the expense. Thus, current systems can only tell the procurement manager that an aggregate amount X was paid for security guard services over a given time period, but cannot provide further detail. Continuing with our example, in response to our follow-up question, the procurement manager cannot answer whether the expenditures for security guards were over (or under) budget because of changes in the rates paid for the guards' straight-time hours, the rates paid for overtime hours, the quantity of straight time or overtime hours incurred, the mix of junior to senior guards, increases in taxes paid to local jurisdictions at the Buying Entity's international facilities, or some of each factor? To make such a determination, the procurement manager needs information about each purchase at the invoice level of detail, referred to herein as Invoice Detail Information (“IDI”).

Currently, to obtain this level of information, the procurement manager has to retrieve the physical invoices and manually perform an audit. If he is lucky, he will find that there exists sufficient data on the invoices to determine an answer; however, most of the time the procurement manager will be unlucky—he will find inadequate, imprecise, and frequently erroneous information on the physical invoices. Frequently, the procurement manager will find no invoice detail information at all in the case of “single sum” invoices for “services rendered”—but paid in an extremely timely and efficient fashion by the current art. Compound the IDI problem further by recognizing that security guards are but one instance among hundreds of discrete goods and services a Buying Entity may purchase (e.g., security guard services, desktop personal computers, advertising agency compensation, etc.), each with its own unique specifications, pricing, and units of measure. Specifications refers to the characteristics of the goods or services that help define exactly what is being purchased. For example, the specification for security guard services may include the type of guard, an hourly rate, and the number of hours worked. For desktop personal computers, the specification may include, for example, the type of CPU, the size of the monitor, the amount of RAM, the size of the hard drive, etc.

Other problems arise from the inability to examine purchases at the IDI level of detail. One such problem is the inability to automate the monitoring of contract compliance, i.e., where a contract has been executed for the purchase of goods or services, determining whether a subsequent purchase for that good or service meets the terms of the previously executed contract. For example, assume that the Buying Entity had previously negotiated a contract with our security guard firm detailing the rate to be paid per regular hour worked for each type of guard the Buying Entity thought they might need over an upcoming period of time, which might be a year or several years. However, let us further assume that during the course of the contract, inflation is higher than the security guard services firm had forecast due to an increase, say, in the price of oil. Security guard services firms frequently run fleets of vehicles to enable their guards to effectively patrol large plant facilities of their customers and are therefore consumers of gasoline. In an effort to restore its profitability margins, and not wanting to technically violate the terms and conditions of its signed contracts with its large Buying Entity customers concerning the price paid per hour for the security guards themselves, our security guard firm announces a new “fuel surcharge” in a letter to its Buying Entity customers, and begins to place the new fuel surcharge on its invoices. Now depending upon how vigilant the Buying Entity is, it might or might not catch this billing slight-of-hand, particularly if no purchase order was ever issued in connection with the contract. (In practice, it is not uncommon to find that only a small proportion of a Buying Entity's purchased goods and services ever have a purchase order issued for them.) Clearly, though, human intervention is now required on the part of the Buying Entity in order to determine, for example, the dollar magnitude and significance of the fuel surcharge. This human intervention is expensive. Rational procurement executives of Buying Entities are forced to make trade-offs every day as to how to allocate the scarce time of their procurement staff. Even assuming that the Buying Entity had someone whose job it was to chase after billing anomalies, the technology has not existed to enable procurement executives to quantify these trade-offs and focus their scarce attention on those variances where additional management attention is most likely to yield a financial return to the Buying Entity. For example, many variances between Expected Price and actual price deserve no management attention, as in, for example, a change in the local tax rates that are beyond the power of the organization to control.

In the field of contract management systems, there exist numerous means to aid the procurement manager in efficiently drafting and organizing written terms and conditions for commercial contracts. Once the contract is executed, however, the art of the contract management systems field abandons the procurement manager when it comes time to verify compliance with contracted prices. The most common current technique for verifying an invoice in compliance with contract terms and conditions is to insert an employee, or set of employees, of the Buying Entity, who are familiar with the contract terms and conditions, into the manual approval loop for the invoice(s) applicable to that contract. Clearly, manual contract compliance is an expensive business process.

Another approach to dealing with the contract compliance problem, known as the “master/vendor” structure, has also developed, with or without one of the various “self service” e-procurement systems managing order flow between the Buying Entity and the suppliers. Because of the expense of the Buying Entity contract compliance problem and because undetected contract compliance errors can have enormous financial impact given the large transaction volumes flowing through commercial contracts, in some cases even the structure of entire industries have evolved over time to lower the transactions costs of the compliance problem for Buying Entities. Supplier industry structures, such as the “master/vendor” structure, have evolved to attempt to lower the costs of contract compliance measurement for Buying Entities.

A prominent example of the so-called “master/vendor” structure occurs in contingent-labor related industries such as temporary services. As an illustration, a temporary services master/vendor is a temporary services agency that contracts to supply Buying Entities with temporary workers and in return the Buying Entity agrees to funnel a large proportion (or, frequently, all) of its orders for temporary services through the master/vendor. The master/vendor typically fulfills some of the Buying Entity's orders internally, by placing individuals from its own staffing pool into the positions generated by the Buying Entity's order flow, or it subcontracts the orders to other temporary service firms if, on a given day, it cannot fulfill an order from its own staffing pool. Critically, however, the master/vendor sees all of the Buying Entity's order flow, regardless of which temporary service agency actually fulfills a given order. Periodically, and more recently, in real-time, the master/vendor generates reports for the Buying Entity detailing activity about the Buying Entity's order flow. If a Buying Entity is successful in routing substantially all of its order volume through the master/vendor, then the master/vendor's periodic reports can be used to verify contract compliance. Historically it has been a difficult task for a large Buying Entity to route substantially all of its orders through a master/vendor, particularly for Buying Entities that operate internationally, with the result that large pools of purchases end up being fulfilled with firms other than the designated master/vendor. Interestingly, a major selling point of the recently announced “self-service” e-procurement systems is precisely that they create a means to capture substantially all of a Buying Entity's order flow, thereby releasing one historical constraint on utilizing the master/vendor structure to lower the costs of contract compliance.

It is important to remember that the generalized procurement problem facing the Buying Entity is to minimize three factors simultaneously for any given transaction: the cost of the good or service at the sought specification, the process costs of the transaction itself, and the costs of compliance. It is useful to observe that self-service e-procurement systems focus on the middle factor of these three, the process costs of the transaction itself, while relying on other mechanisms to handle the other two. In the case of compliance costs, e-procurement systems rely upon simple contracting structures such as the master/vendor contracting structure. In the current art, even the most advanced e-procurement systems have no mechanism to lower the contract compliance costs of the Buying Entity that deals directly with a complex and diverse vendor set numbering in the hundreds or thousands of discrete firms. Furthermore, in practice, simple contracting structures (sole sources, master/vendors, and the like) tend to yield mediocre results when it comes to minimizing the first part of the procurement equation above, the cost of the good or service at the sought specification. To take the example of the temporary services master/vendor, the act of entering into a contract with such a master/vendor forces a Buying Entity to sacrifice a significant portion of its market leverage over the price of temporary services workers, as the Buying Entity loses the ability to arbitrage the contingent labor market on a day-to-day basis. (Indeed, it is the master/vendor who gains that ability by the very nature of the contract!) However, with the advent of sophisticated, interconnected electronic markets in all manner of goods and services, including PRIVATE RATECARD and PUBLIC RATECARD systems that perform real-time pricing in markets such as temporary services, it becomes a very high cost solution indeed for a Buying Entity to foreclose itself from taking advantage of the benefits that these developments entail.

### SUMMARY OF THE INVENTION

To redress the deficiencies and expense of the current state of contract compliance, the present invention provides a generalized mechanism, applicable across all types of goods and services, referred to herein as Spending Categories, to collect and represent Expected Price and Expected Quantity at the relevant specification for any or all contracts available to a Buying Entity as well as a generalized method for comparing IDI to Expected Price and/or Expected Quantity information by the relevant specification so as to be able to track vendor compliance. Thus the system of the present invention generates a benefit to any Buying Entity for whom the cost of the system is less than the transactions costs and opportunity costs inherent in the current art.

The system of the present invention, known as the Market Measurement System (“MMS” or “MM System”), is a processing system designed to implement any or all of the following three processes for a Buying Entity: (1) a generalized method for collecting and a data structure for representing Invoice Detail Information (“IDI”), particularly price, quantity, and specification information, (2) a generalized method for collecting and a data structure for associating Expected Price and/or Expected Quantity for future transactions with the corresponding specification for those transactions across any or all contracts available to a Buying Entity, and (3) a method for comparing generalized Invoice Detail Information with the corresponding Expected Price and/or Expected Quantity information by the relevant specification.

Comparisons of the Invoice Detail Information and generalized Expected Price and Expected Quantity information at the corresponding specification have a high degree of commercial relevance to procurement decision makers in Buying Entities.

Take the case of a global corporation buying, for example, security guard services for their administrative offices and warehouse facilities in 100 different regional markets across the world. A system of the present invention can inform the procurement manager whether it is the case that any of the dozens of security guard firms his corporation contracts with globally are in compliance with the principal pricing terms of his organization's commercial procurement contracts governing security guard services, and the magnitude of and root cause for any variances.

“Specification” refers to any given set of characteristics for a commodity such that a single price and a single quantity may be associated with a transaction for that commodity between a particular buyer and seller. In practice, an invoice contains one or more transactions. Each combination of commodity, buyer, and seller, may then have a unique set of characteristics which provide the specification. Thus, the present invention relates to a system and method for collecting and analyzing input data for specifications, where the input data may relate to transactions involving a plurality of commodities, where the input data may be received from a plurality of suppliers for each commodity, and where, for each transaction, the input data describes each characteristic of the specification for the commodity that is the subject of the transaction.

The above described concepts are achieved by a computer implemented method for processing data representing transactions involving a plurality of commodities and one or more suppliers for each of the plurality of commodities. The method involves receiving data representing a transaction involving one of the plurality of commodities, the data having a format and including a price, a quantity, two or more characteristics of the commodity involved in the transaction, and the identity of the supplier of the commodity involved in the transaction. Then, the data is translated from the format in which it was received into an internal format, where the internal format allows for the price, the quantity, each of the commodity characteristics, and the supplier identity of the data representing the transaction to be directly accessed. Finally the translated data is stored for later use.

The data representing transactions is received at an Import Data Subsystem which translates the data from the format in which it was received to an initial internal format and may then store the translated data at an import data store. The format in which the data was received may be one of a plurality of external formats. In such a case, the Import Data Subsystem may employ external format translation rules, which relate each external format to the initial internal format, to translate input data from any external format to the initial internal format. In an embodiment of the invention, the MM System may employ a plurality of initial internal formats, each of which is specific to a particular commodity and particular vendor of that commodity. In that case, the Import Data Subsystem may employ external format translation rules which relate each external format to each of the plurality of initial internal formats.

A Parse Data Subsystem translates the data at the import data store from the initial internal format in which it was stored to a MMS Standard Transaction format. The MMS Standard Transaction format is the same regardless of which commodity and vendor of that commodity is related to the transaction. The MM System includes a set of MMS data translation rules that are unique to each specific commodity and may also be unique to each vendor of each commodity for translating data from each initial internal format to the MMS Standard Transaction format. For each transaction in the input data, each set of MMS data translation rules relates the location, within the initial internal format, of the price information, the quantity information, and the information for each characteristic of the specification for that specific commodity (and also the specific vendor of that commodity, if necessary) to the corresponding location for the same information in the MMS Standard Transaction format. The Parse Data Subsystem may then store the data translated into the MMS Standard Transaction format at the MMS database for later use.

If it is desired to verify the accuracy of the stored input data, the MM System may perform an optional verification procedure after the data is translated into the MMS Standard Transaction format. In this verification procedure, the stored input data may be compared to other data describing the same transactions as the stored input data. If the data is so verified, it may be assigned tracking information and then stored at the MMS database.

Using the input data converted to the MMS Standard Transaction format, the MM System may perform calculations and produce reports on the input data based on price, quantity, one or more characteristics of the specification for a commodity, and if desired, any one or more of these in relation to an internal or external benchmark, or both.

In another embodiment of the invention, the input data may be stored and remain in the initial internal format rather than further translating the data to the MMS Standard Transaction format. The MM System then may employ MMS data translation rules to extract the stored data, process it, and produce reports, as described above.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing an embodiment of the present invention.

FIG. 2 is a flow chart showing the operation of an embodiment of the present invention.

FIG. 3 is a block diagram showing another embodiment of the present invention.

FIG. 4 is a flow chart showing the operation of another embodiment of the present invention.

FIG. 5 is a block diagram showing the types of input data that may be received by the Import Data Subsystem of the present invention.

FIG. 6 is a table illustrating a sample data submission for the Security Guards Spending Category.

FIG. 7 is a table illustrating sample data from an Accounts Payable System.

FIG. 8 is a table showing various examples of Spending Categories.

FIG. 9 is a block diagram showing the integration of FIGS. 9A and 9B.

FIGS. 9A and 9B show a table of records having the MMS Standard Transaction Format.

FIGS. 10A through 10H are flow charts showing the operation of the Parse Data Subsystem of the present invention.

FIG. 11 is a table showing an example of a Vendor table.

FIG. 12 is a table showing examples of records excerpted from a Multi-Category Field Mapping table, where the excerpted records relate to one vendor in one spending category.

FIG. 13 is a table showing an example of a Transaction table including Mapping Codes.

FIG. 14 is a table showing an example of a Specifications code table.

FIG. 15 is a table showing an example of a Pricing table.

FIG. 16 is a table showing a comparison of system calculated invoice information with vendor reported invoice information.

FIG. 17 is a table showing an example of a Cross Reference table.

FIG. 18 is a table showing an example of a Benchmarks/Normalization table.

### DETAILED DESCRIPTION OF THE PREFERRED EMBODIMENTS

The accompanying Appendices, which are incorporated in and constitute a part of this specification, together with the description, serve to explain the principles of the invention:

Appendix 1 is a table showing examples of spending categories; and

Appendix 2 is a table showing an example of a Multi-Category Field Mapping table for various spending categories and various vendors.

The present invention may be implemented in any computer system, which may exchange data through any means, such as a network, e.g., Internet, WAN, LAN, VPN, or physical media, e.g., CD-ROMs, or floppy disks.

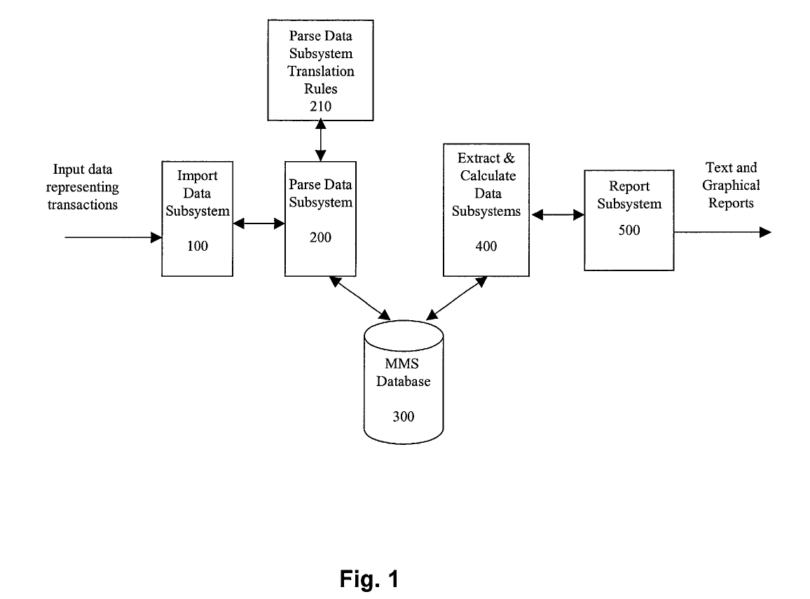

The Market Measurement System (“MMS”) is designed to capture detailed purchasing data at either or both the point of purchase or the point of payment and to convert this data into managerially relevant reports for procurement decision makers. FIG. 1 is block diagram showing the components of an embodiment of the invention. The invention includes several computer subsystems. Computer subsystem here is used broadly to mean computer hardware and software, e.g., a distinct computer, or computer software only, e.g., as one computer application executing within a computer. An Import Data Subsystem (“IDS”) 100 is in communication with a Parse Data Subsystem (“PDS”) 200. The components of the invention may communicate with each other through any means desired for allowing computer systems to communicate with each other. For example, where IDS 100 and PDS 200 are distinct computers, they may communicate with each other via a computer network to which they are both attached. Alternatively, where IDS 100 and PDS 200 are distinct computer processes executing on the same computer, they may communicate via intra-computer, inter-process messaging.

Returning to FIG. 1, the PDS 200 is in communication with stored, predefined translation rules 210, which may be referred to as Parse Data Subsystem Translation Rules, and a database 300, also referred to as the MMS Database. An Extract and Calculate Data Subsystem (“ECDS”) 400 is in communication with MMS Database 300. Finally, a Report Subsystem (“RS”) 500 is in communication with ECDS 400.

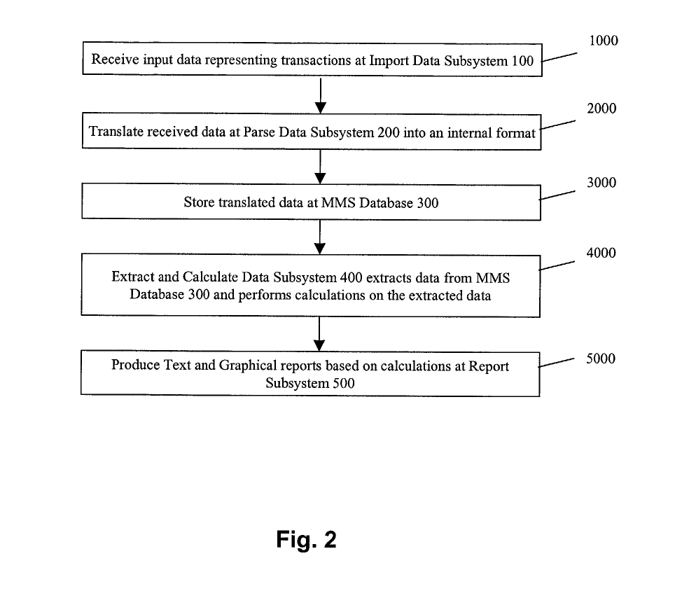

FIG. 2 is a flow chart describing the operation of an embodiment of the invention. First, input data representing transactions is received at IDS 100, step 1000. The PDS 200 consults the PDS translation rules 210 to translate the received data from the format in which it was received to a format used internally within the MM System, step 2000, and then stores the translated data at MMS Database 300. At any time after the translated data is stored at MMS Database 300, ECDS 400 may extract data from MMS Database 300 and perform calculations on the extracted data, step 4000. Report Subsystem 500 may then use the extracted data and calculations to produce reports, which may include text and/or graphics, step 5000.

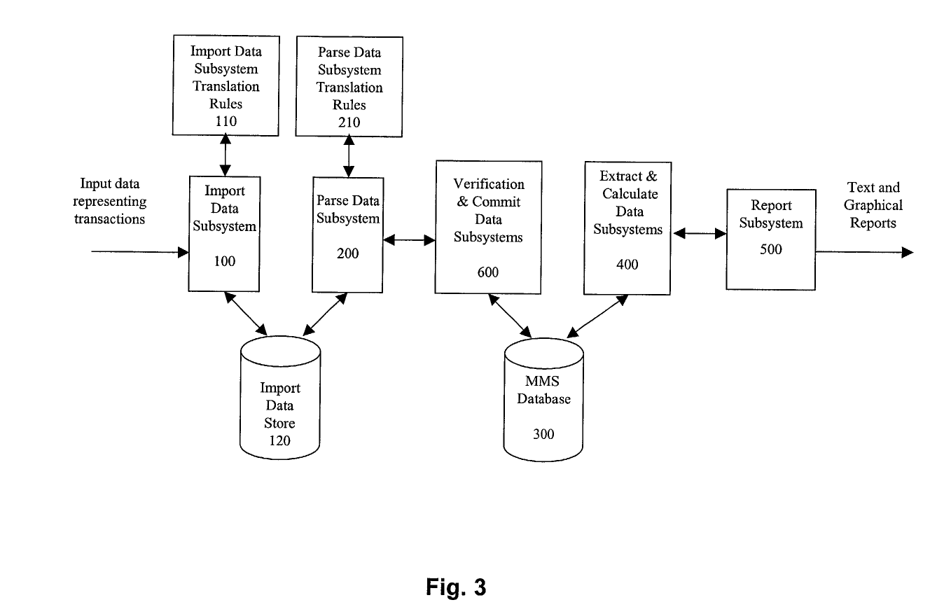

FIG. 3 is a block diagram showing the components of another embodiment of the invention. IDS 100 is in communication with translation rules 110, which may be referred to as Import Data Subsystem translation rules, and a database 120, which may be referred to as the Import Data Store. PDS 200 is in communication with the PDS translation rules 210, the Import Data Store 120, and a Verification and Commit Data Subsystem (“VCDS”) 600. VCDS 600 is in communication with the MMS Database 300. ECDS 400 is in communication with MMS Database 300 as well as Report Subsystem 500.

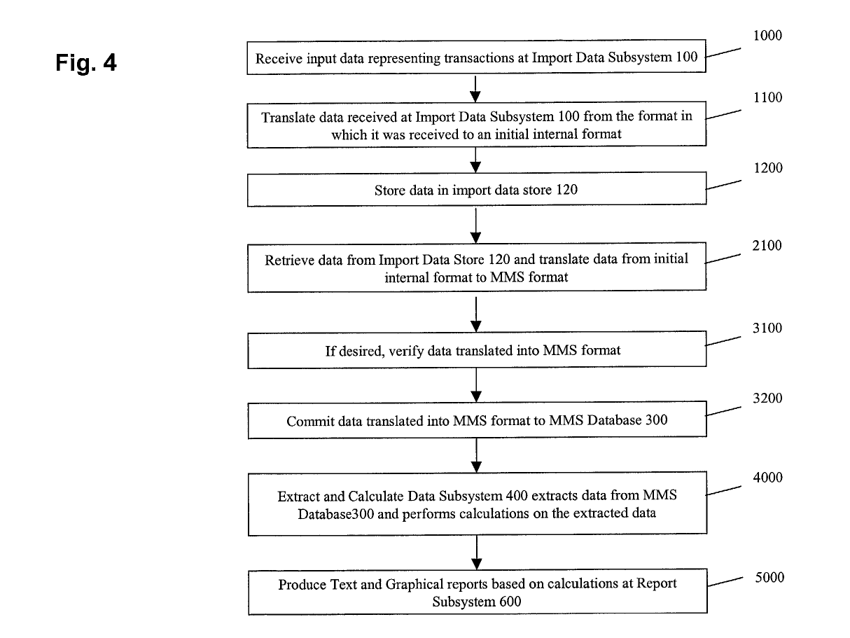

FIG. 4 is a flow chart showing the operation of another embodiment of the invention. At step 1000, input data representing transactions is received at IDS 100. The IDS 100 consults IDS translation rules 110 to translate this received data from the format in which it was received to a first internal format, step 1100. This data is then stored in the import data store 120, step 1200. Next, in step 2100, the PDS 200 retrieves the data that has been translated into a first internal format from the import data store 110 and the PDS 200 consults PDS translation rules 210 to translate this retrieved data from the first internal format to a second internal format, which may be referred to as the MMS format.

At step 3100, an optional procedure may be performed where the data which has been translated into the MMS format may be verified against other data representing the same transaction. If the optional verification procedure of step 3100 is performed, then processing continues with step 3200 only if the data translated into the MMS format is successfully verified. If the optional verification procedure of step 3100 is not performed, then processing proceeds from step 2100 directly to step 3200. At step 3200, the data translated into the MMS format (and successfully verified if the verification procedure is performed) is committed to the MMS database 300.

At any time after data translated into the MMS format is committed to the MMS Database 300, ECDS 400 may extract data from MMS Database 300 and perform calculations on the extracted data, step 4000. Report Subsystem 500 may then use the extracted data and calculations to produce reports, which may include text and/or graphics, step 5000.

The subsystems described above and their operations are described in more detail below.

Import Data Subsystem

The Import Data Subsystem (“IDS”) functions as the data input interface for the MM System. The IDS receives various types of input data from various external sources and stores this data in a database, e.g., the import data store, for later use by the MM System. Since each type of input data from each external source may be in a different data format, the IDS also converts the input data that it receives from the various external formats to a single initial format that is used internally by the MM System. For example, the initial format used may be MICROSOFT Access table format. To perform this translation, the IDS 100 consults external format translation rules, which may also be referred to as IDS translation rules, which describes how each external format is related to the initial internal format.

The input data received at the IDS must describe a transaction, e.g., a purchase of a commodity, with sufficient detail to determine the basis for the price for that commodity for that transaction. Such input data will describe the transaction by providing the price, quantity, and specification of the commodity involved. Any given set of characteristics for a commodity sufficient to determine the price of that commodity for a transaction between a particular buyer and seller can function as a specification. Each combination of commodity, buyer, and seller, may then have a unique set of characteristics which provide the specification.

For example, many manufacturers use the stock keeping unit (“SKU”) method for identifying specifications for products. Thus, a personal computer manufacturer's SKU number for a personal computer could uniquely identify a model having a Pentium III CPU at 1 GHz clock speed, a 6 gigabyte hard drive, a 15″ SVGA display, 128 MB RAM, and any other features jointly agreed upon between the manufacturer and the buyer. SKUs can be either published or unpublished (i.e., prearranged privately between a buyer and seller).

In another example, such as security guard services bought in large quantities by a corporate Buying Entity, the specification may be prearranged between a buyer and a seller to include the guard type (level of seniority), a regular hourly rate per hour, the number of regular hours that should be worked for a given week, an overtime hourly rate, the number of overtime hours that should be worked for a given week, etc.

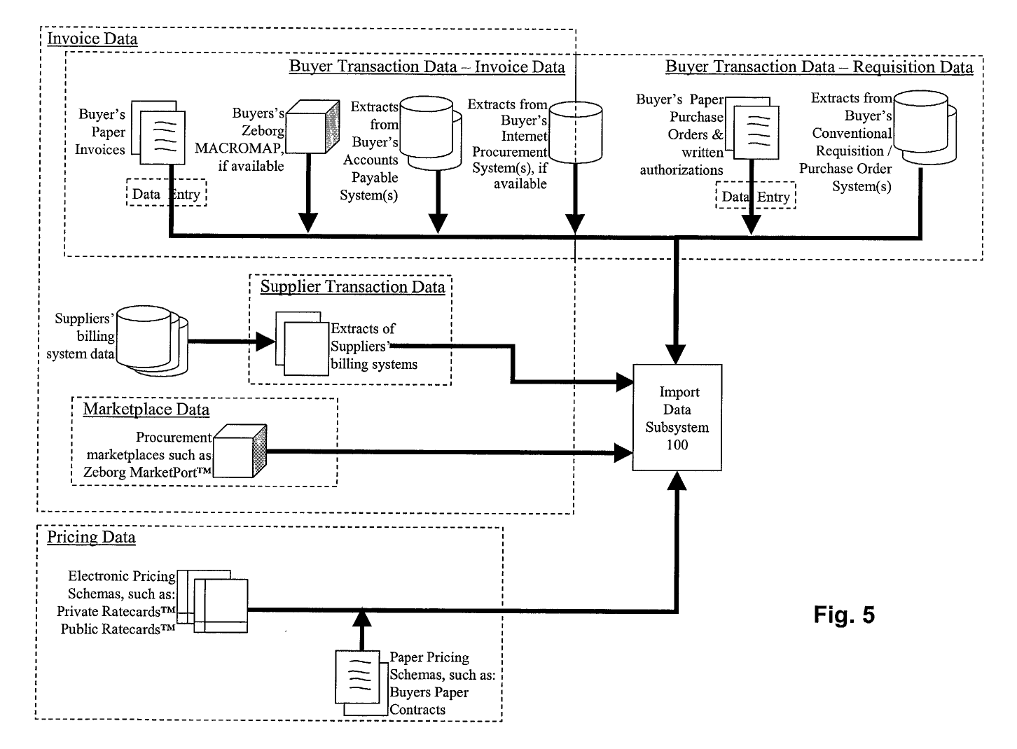

IDS 100 may receive various types of input data from a variety of sources. FIG. 5 is a block diagram that illustrates the types of data that the IDS may receive and sources from which the data may originate. As shown in FIG. 5, the types of input data that the IDS may receive include, but are not limited to: (1) supplier transaction data from suppliers (also referred to herein as vendors); (2) a Buying Entity's own transaction data; (3) Procurement marketplace data; and (4) pricing data.

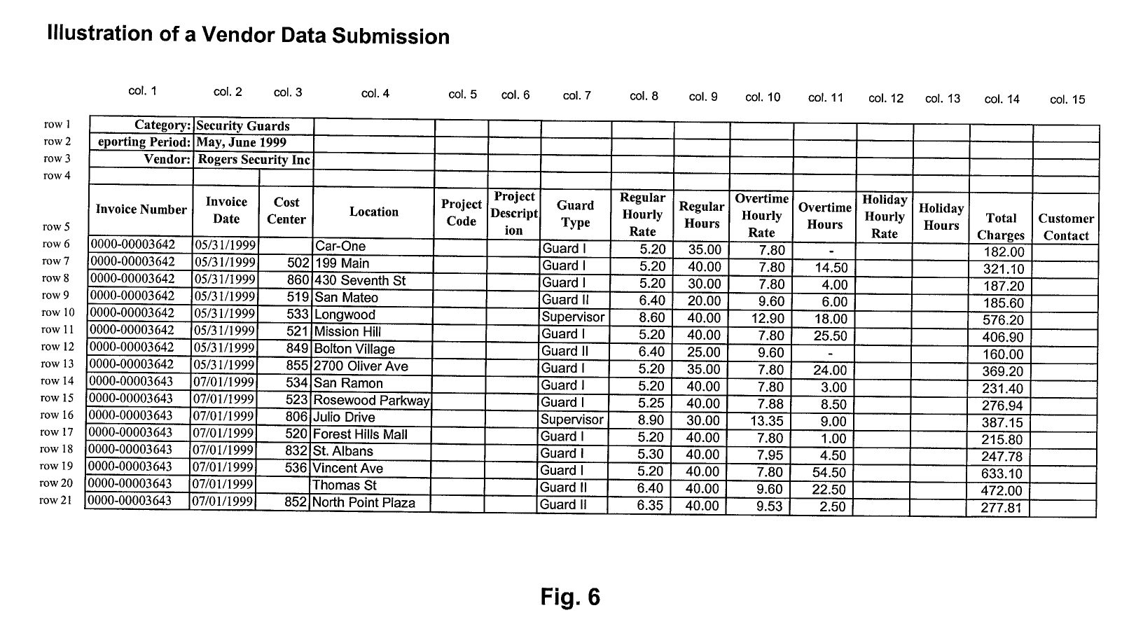

A vendor may submit supplier transaction data to the IDS in any known data format, such as, for example, the MICROSOFT Excel spreadsheet format, or a comma delimited file. FIG. 6 is a table that illustrates a vendor submission of supplier transaction data in MICROSOFT Excel format.

Vendors may transmit the supplier transaction data to the IDS in any known manner. For example, vendors may submit electronic files by sending the file in an e-mail to a published internet mailbox address designated for that purpose, mailing the file on a diskette via to conventional post or express mail service, or via web data upload interface designed for this purpose.

Referring again to FIG. 5, another type of input data that may be received by the IDS is the Buying Entity's transaction data. The Buying Entity referred to here is the Buying Entity operating the MM System of the present invention. A Buying Entity's transaction data may include either or both requisition data and invoice data. Requisition data may be submitted to the IDS from any or all of the following sources and data formats: paper purchase orders, the Buying Entity's written procurement authorizations, and data feeds from the buyer's requisitioning system(s) and purchase order system(s). Invoice data may be submitted to the IDS from sources and in data formats including the following: the Buying Entity's paper invoices, data feeds from the Buying Entity's Accounts Payable system(s), and data feeds from any procurement data warehouses such as the ZEBORG MACROMAP, if available. If available, the Buying Entity's internet procurement system(s) could supply either or both requisition data and invoice data.

Invoice data refers to Buying Entities' paper invoices, ZEBORG MACROMAP extracts, Accounts Payable system extracts, Internet procurement system extracts, supplier billing system extracts, and e-marketplace data. Invoice data excludes and requisition data includes Buying Entities' purchase orders and requisition system extracts.

Another type of input data that may be received by the IDS is pricing data. Pricing data may be submitted to the IDS from sources and in data formats including: PRIVATE RATECARD systems, PUBLIC RATECARD systems, and any other pricing sources available to the Buying Entity. A PRIVATE RATECARD is an electronic or paper schedule that contains a set of prices agreed upon between a buyer and a vendor resulting from the conclusion of negotiations and a formula used to translate a specification for future work into a total job price using the agreed upon set of prices. The terms of a PRIVATE RATECARD are generally known only to one supplier and one Buying Entity. PRIVATE RATECARD(s) whose terms are published and made available to large numbers of Buying Entities and suppliers are known as PUBLIC RATECARD(s).

Another type of input data that may be received by the IDS is procurement marketplace data, such as, for example, data from transaction e-marketplaces, such as ZEBORG MARKETPORT.

The Import Data Subsystem 100 may be implemented a number of ways. For example, the IDS may be a database application (such as, for example, a MICROSOFT Access database application) that operates within a single computer housing all the subsystems of the MM System, or it may be implemented as a computer system with database functionality that has communication links with the rest of the MM System.

The IDS 100 has external data communication links which allow it to easily receive input data electronically, e.g., via e-mail or the Internet. Where input data has a physical form, e.g., floppy disks or paper, the IDS has facilities for receiving such data and an MM System operator is available to feed the data into the IDS, e.g., by keying paper based information directly into the IDS.

Input data may be received from one or more sources so long as the aggregate amount of data received for a particular transaction provides price and quantity at the requisite specification level, where the characteristics describing the specification for the commodity have been previously agreed upon between buyer and seller. If, for a particular transaction, a single input data submission does not contain sufficient information, then that initial input data submission may be held at the IDS until such time as additional input data submissions, possibly from other sources, provide the information that completes the price, quantity, specification information for the transaction.

For example, a vendor may submit supplier transaction data to the IDS via a MICROSOFT Excel spreadsheet, as shown in FIG. 6. For a purchase transaction of security guard services for the reporting period of June 1999, this input data submission, does by itself, include sufficient price, quantity, and specification information because the columns shown in FIG. 6 correspond to all the characteristics needed to define the specification for security guard services as previously agreed upon between the buyer and seller.

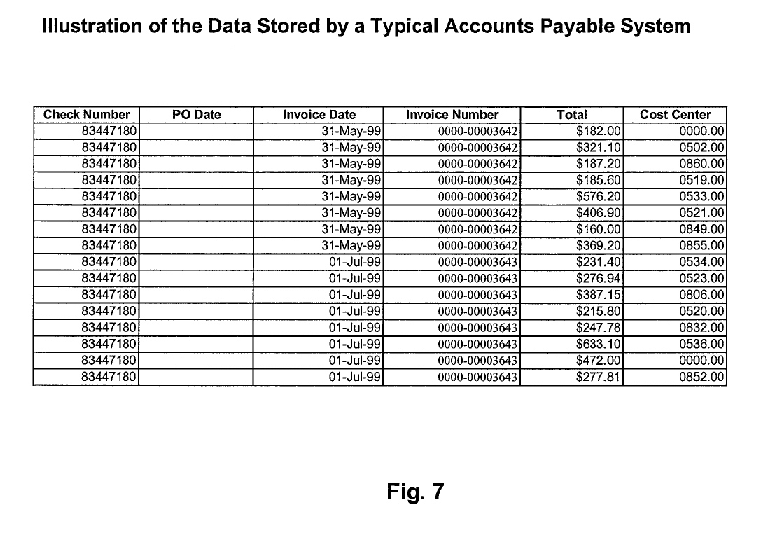

In another example, suppose an initial input data submission consisted of a data extraction from an Accounts Payable system which provided only total cost information and cost center information. An illustration of such an initial input data submission is shown in FIG. 7, which is a table that provides an example of data stored by a typical Accounts Payable System corresponding to the same data of FIG. 6. The IDS would determine, for example through manual observation and intervention by the system operator or by automated inspection of the fields, that this initial input data submission did not contain sufficient price, quantity, and specification information for that transaction. Consequently the IDS would hold that input data submission in storage. Later, if an additional input data submission is received at the IDS for the same transaction, then that data is merged with the data from the previous submission for this transaction that has been stored. In this way, additional input data submissions may be received at the IDS for a particular transaction until the IDS, for example through a system operator or by the IDS Validation procedure described below, determines that sufficient price, quantity, and specification information has been received for the transaction.

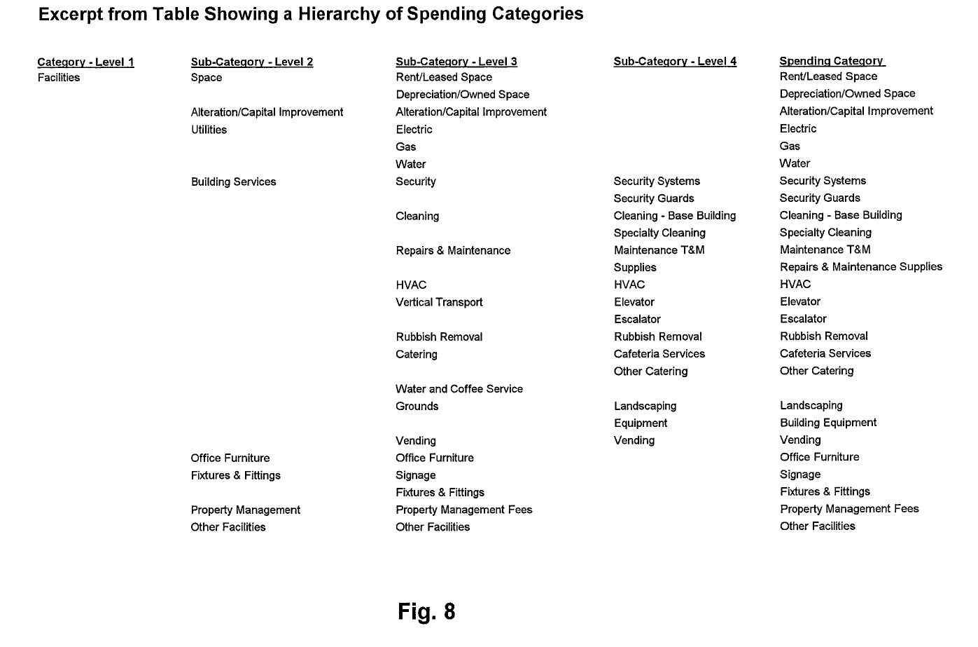

Once input data for a particular transaction has been received that sufficiently describes the transaction at a price, quantity, and specification level of detail, whether that input data is received in one or multiple input data submissions, then the MM System operator assigns, to that set of input data, both a vendor name and a Spending Category from predefined lists of same before processing the file further, if that information was not already provided in the received data submission. A Spending Category is a type of good or service. FIG. 8 is an excerpt from a larger table listing examples of Spending Categories for a typical corporate Buying Entity. The table from which FIG. 8 is excerpted provides more examples of spending categories and appears as Appendix 1.

If desired, during the importation process of the IDS, the IDS may perform an initial data validation on the received data (“IDS Validation”). It should be noted that such a validation is not required. For this IDS Validation, the IDS may run a series of routine checks on the data in the file to assess the level of data integrity in the file. The data validation performed is not intended to be comprehensive as additional validation checks may also occur in the next subsystem of the MMS. Errors that this IDS Validation process identifies include, but are not limited to, the following: incorrect data format (e.g., wrong number of rows or columns), data mismatch (e.g., wrong vendor, wrong category, or wrong buyer), duplicate data (e.g., the data in the import dataset already exists in the system), missing data (e.g., no data where data fields are required), data type mismatches (e.g., letters in fields where numbers were expected or viceversa), and values out of range (e.g., numbers too large or too small to be correct for a given field).

To accommodate optional characteristics of a commodity specification previously agreed upon between a buyer and a seller, the format of the data submission to the IDS may be defined to contain optional fields, such as columns 5, 6, 12, 13, and 15 of FIG. 6. Therefore, referring again to FIG. 6, if a vendor submits data for columns 1-4, 7-11, and 14 (which are required), then the submission is accepted even if columns 5, 6, 12, 13, and 15 (which are optional) are blank.

The MM System uses an internal data table, known as the Process Control Table, to track all data and the status of that data as it is processed by the various subsystems of the MMS. Once input data has been imported by the IDS, the MM System updates the Process Control Table to indicate a successful import. If the import fails, the import failure is noted on the Process Control Table, the MM System notifies the operator of the failure, and the operator sends the file back to the vendor for repair and resubmission. Upon the completion of a successful import, the MMS updates the Process Control Table to flag the data as ready for the next subsystem, i.e., Parse Data Subsystem.

Thus, the IDS provides a system through which the MMS can receive price, quantity, and specification information for any type of good or service, i.e., any Spending Category.

Parse Data Subsystem

Once the IDS has imported input data representing a transaction for a given commodity, that input data exists in a data format specific to that commodity. For example, input data relating to security guard services may be in the format shown in FIG. 6, which may differ from a format storing another commodity, such as personal computers. The Parse Data Subsystem (“PDS”) 200 converts the imported data from the initial internal format created by the IDS, to a generalized data format and data structure that may be used to represent any commodity. This second internal data format that is generalized across all spending categories is known as the MMS Standard Transaction Table Format. One data structure which may be used to implement this generalized data format is a relational database. However, it should be noted that in addition to a relational database architecture, any database architecture (e.g., hierarchical, network, etc.) could be used with the system of the present invention.

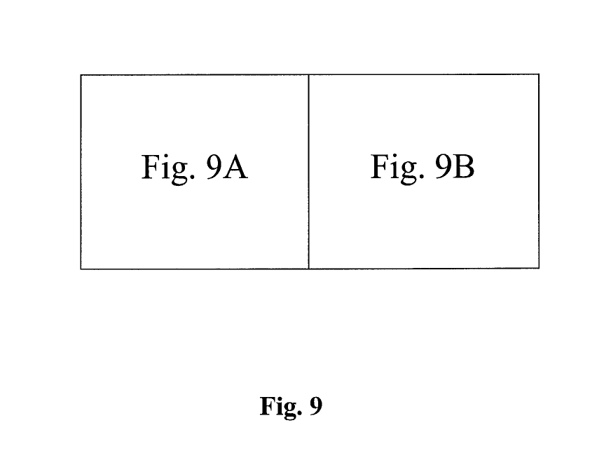

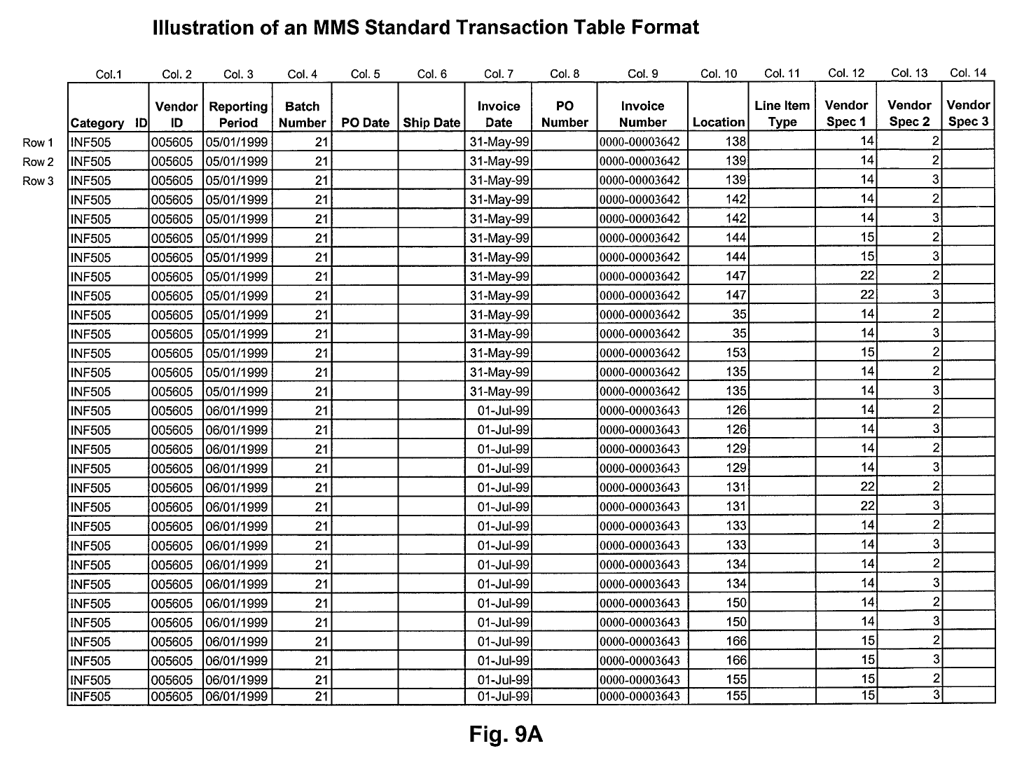

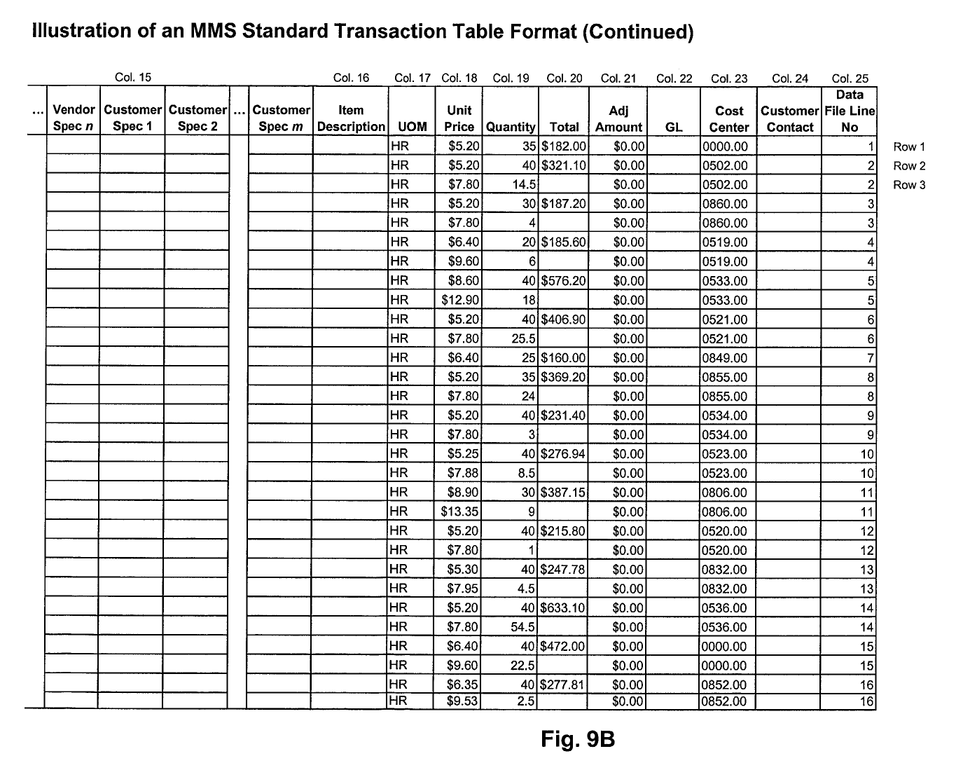

As stated above, the PDS functions to convert data in the initial internal format, into the MMS Standard Transaction Format. FIGS. 9A and 9B are a single table showing the example data submission of FIG. 3 having been converted to the MMS Standard Transaction Format. FIG. 9 is a block diagram showing how FIGS. 9A and 9B should be integrated. While looking at FIGS. 9A and 9B, it may be seen that all of the pricing data items that appeared in the vendor data submission in the example of FIG. 6 have been mapped into the MMS Standard Transaction Format in FIGS. 9A and 9B. The MMS Standard Transaction Format in conjunction with what herein are called collectively the Coding Tables (Locations Table, Specifications Table, Cross Reference Table, Benchmarks/Normalization Table, and Cost Center Table) may comprise the elements of a relational database design for all, and not less than all, relevant pricing attributes for the universe or any subset of the universe of all Spending Categories, such as, for example, FIG. 8 and Appendix 1. (If one wanted a normalized relational database design for less than all relevant pricing attributes for the universe or any subset of the universe of all Spending Categories, one could simply purchase any conventional ERP system.) It should be noted that the general design of the tables could be normalized or denormalized as necessary without sacrificing the utility of the design or the functionality of the system.

The PDS 200 employs PDS translation rules 210 to convert data having any of the initial internal formats into the MMS Standard Transaction Format. The PDS translation rules 210 are predefined and are user editable. The user interface to define and/or edit the PDS translation rules may be accessed via a workstation directly connected to the PDS or it may be accessed via the Internet by a PC with a standard web browser where the PDS and MM System is also connected to the Internet.

In one embodiment of the invention, the PDS translation rules 210 are implemented as Field Mappings that are applied to the imported data in order to produce the MMS Standard Transaction Format as an output. A Field Mapping is a set of instructions for interpreting any of the data submissions collected by the IDS and placed into the initial data format by the IDS and flagged for further processing. There exists at least one Field Mapping for each Spending Category to be handled by the system, and there may be more than one Field Mapping in the event that the Field Mappings vary by vendor within Spending Category. The field mapping logic of the present invention is sufficiently general that it can produce Standard MMS Data Table Format from any source of consistently formatted flat-file transactional data that contains discrete records containing price, quantity, and specification details for each transaction.

In the system of the present invention, each Buying Entity will have their own unique set of Field Mappings for their Spending Categories and vendor sets. A Field Mapping Table contains the schemas for translating the transaction detail information within each spending category into the generic transaction format of the MMS database. A typical corporate Buying Entity, which may be involved in transactions involving commodities of multiple spending categories, may use a Field Mapping Table capable of translating transaction detail information for multiple spending categories into the MMS Standard Transaction Format. Such a Multi-Category Field Mapping Table is shown in Appendix 2.

It is expressly the intention in the design of the system that the scope of the Field Mappings need not cover all of the possible Spending Categories within a Buying Entity. For example, a procurement manager employing the system of the present invention might choose to install the invention one Spending Category at a time, seeking out the most troublesome to monitor Spending Categories first.

The MMS system parses the data submission sequentially, record by record. For example, a data submission, such as in FIG. 6, is read sequentially, row by row, from row 6 through row 21 of the sample vendor data submission, where each row is a record. The algorithm for processing each record is to process each column in the record one at a time.

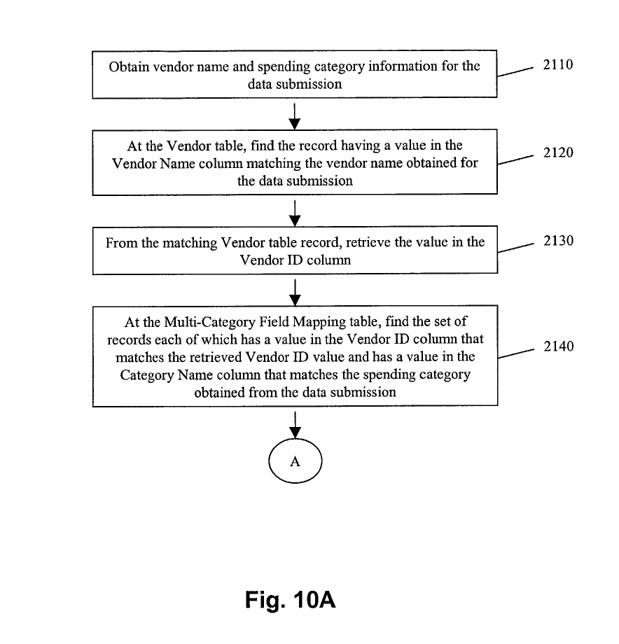

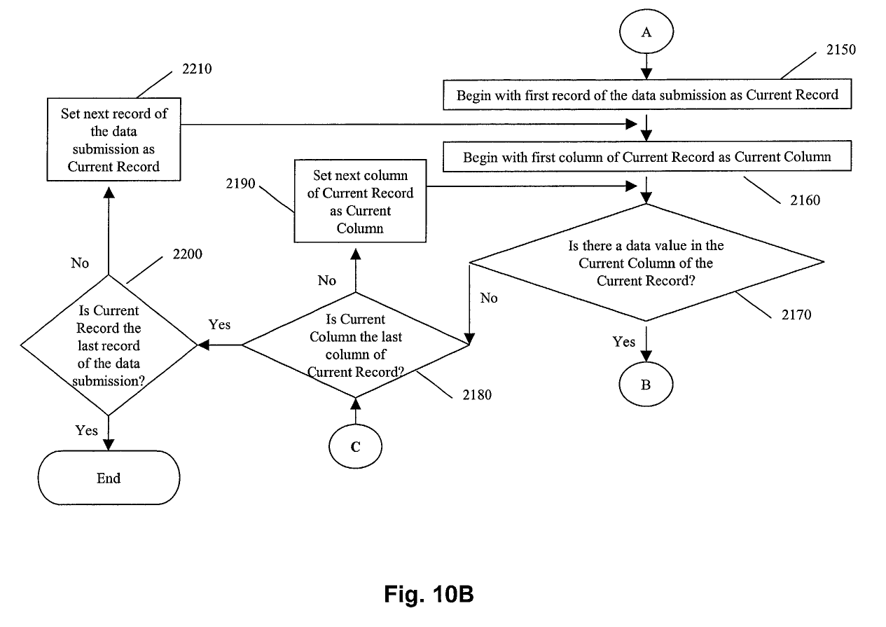

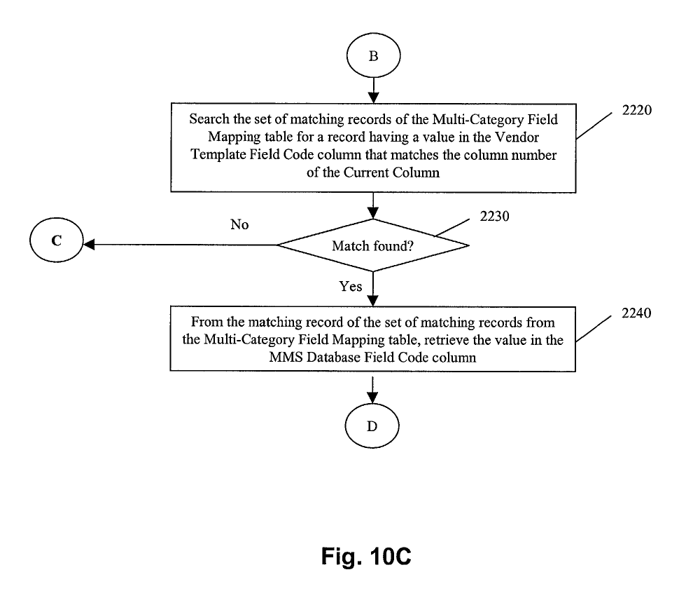

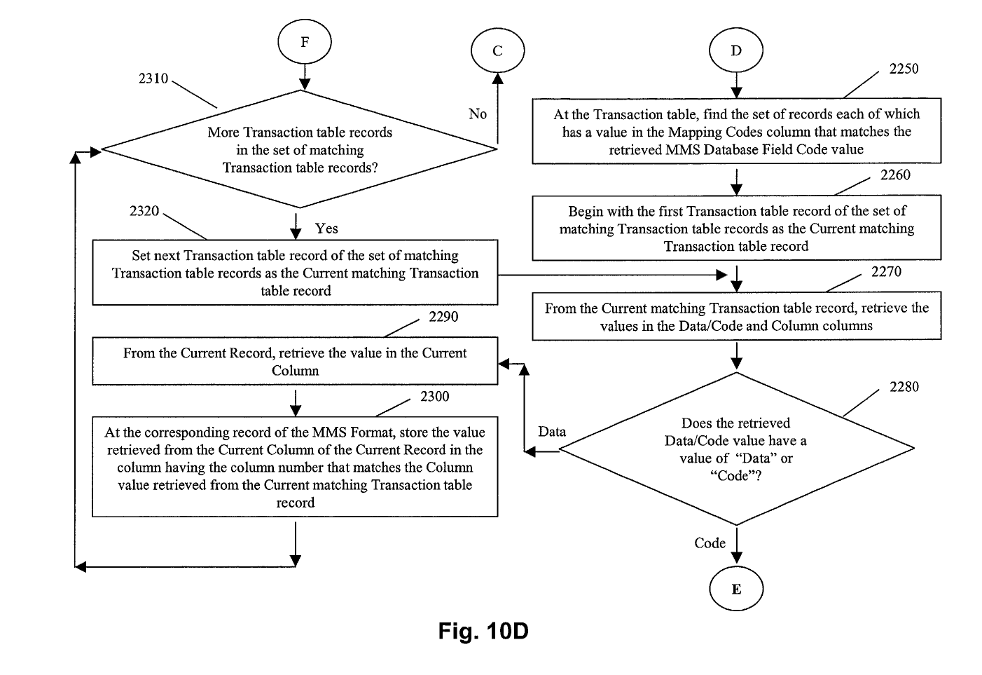

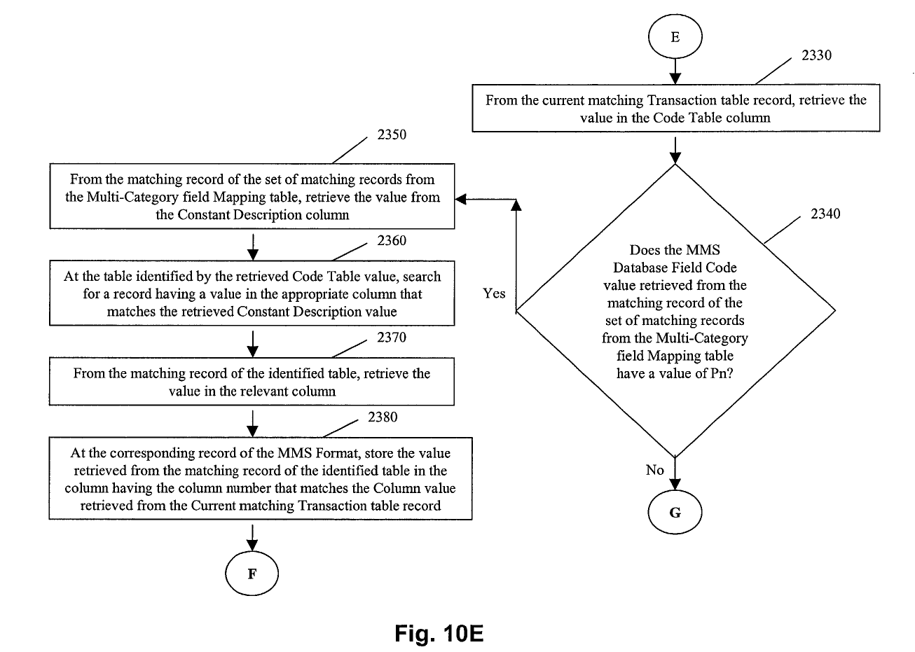

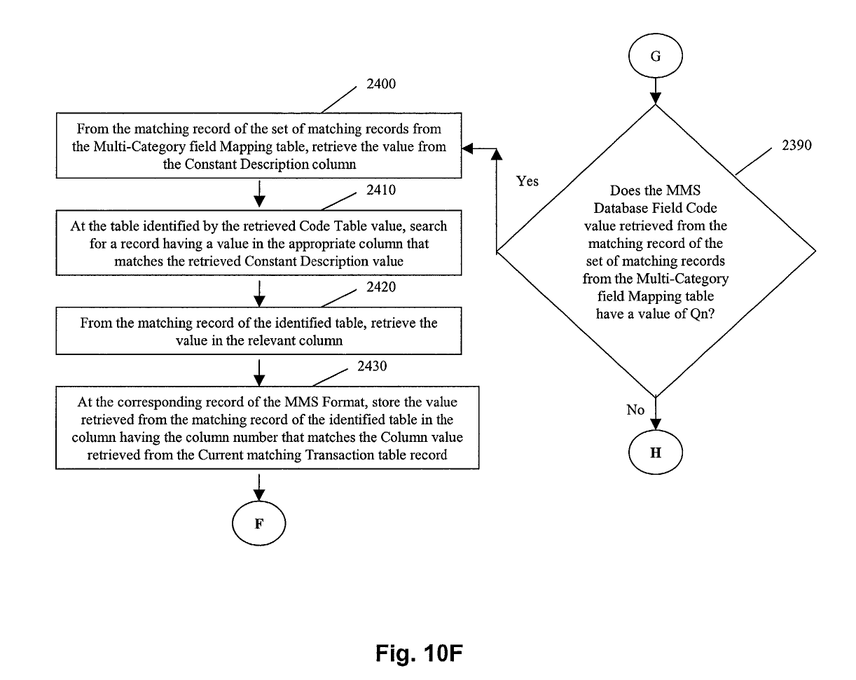

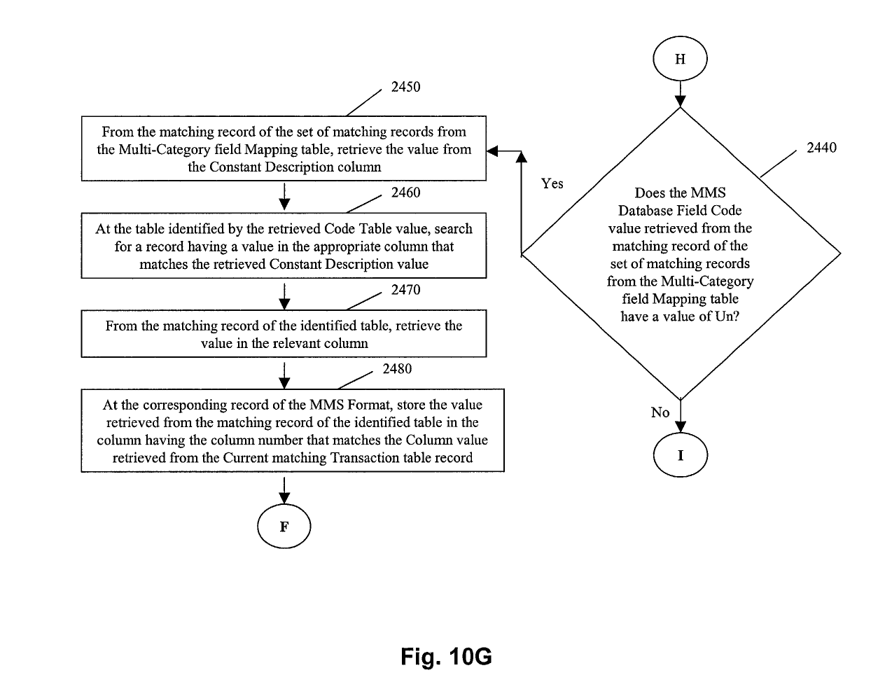

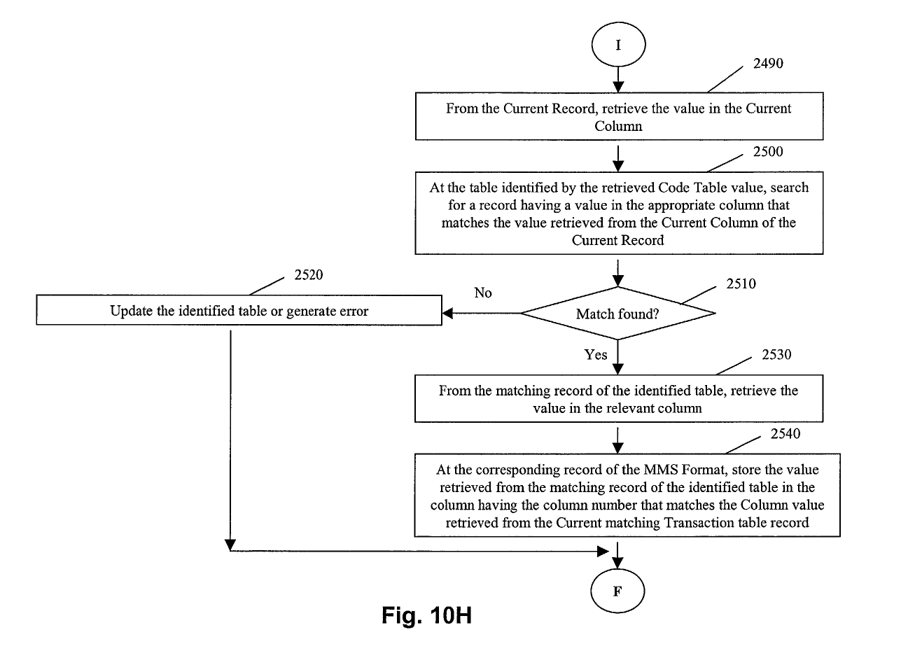

FIGS. 10A through 10H are flow charts which illustrate the translation operation performed by the PDS 200. Referring to FIG. 10A, first vendor name and spending category information is obtained for the data submission, step 2110. As described above, this may be supplied by the system operator at the IDS 100 if the information was not provided in the data submission itself. Referring to the data submission example of FIG. 6, the vendor name and spending category information here has been supplied with the data submission. The PDS 200 obtains the vendor name and spending category information by extracting it from the legend area of the data submission (e.g., the top left corner). Here the vendor name and spending category obtained are “Rogers Security Inc.” and “Security Guards”, respectively.

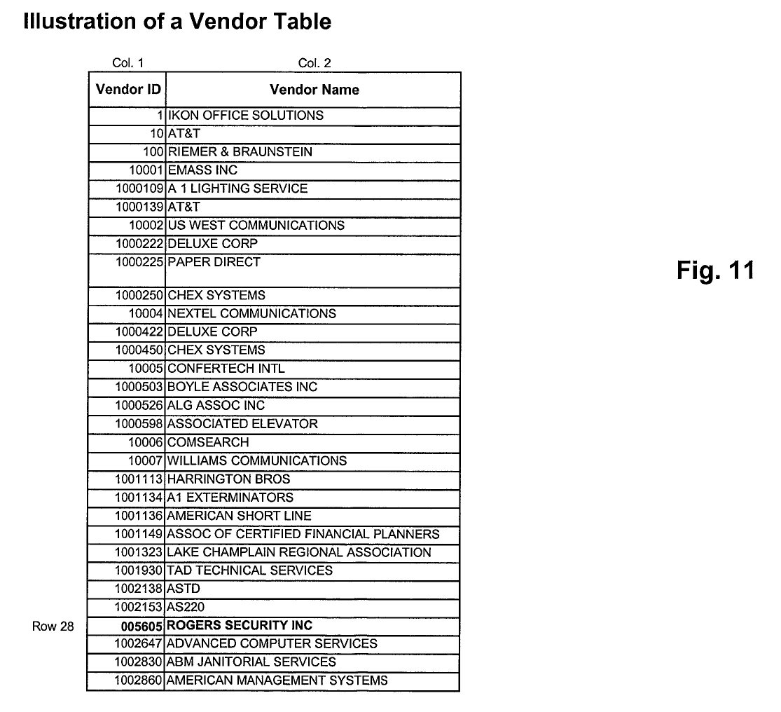

Next, the PDS 200 obtains the vendor ID corresponding to the vendor name obtained. FIG. 11 is a table, which may be referred to as the “Vendor” Table, that shows the correspondence of vendor names and vendor IDs for all vendors having a predefined relationship with the Buying Entity. At the Vendor Table of FIG. 11, PDS 200 searches for the record having a value in the “Vendor Name” column that matches the vendor name obtained from the data submission, step 2120. From the matching record, the corresponding value from the “Vendor ID” column is retrieved, step 2130. Here, the record at row 28 of FIG. 11 is identified as having a matching value for the vendor name “Rogers Security Inc.” in the “Vendor Name” column and the value of “005605” is retrieved from the vendor ID column.

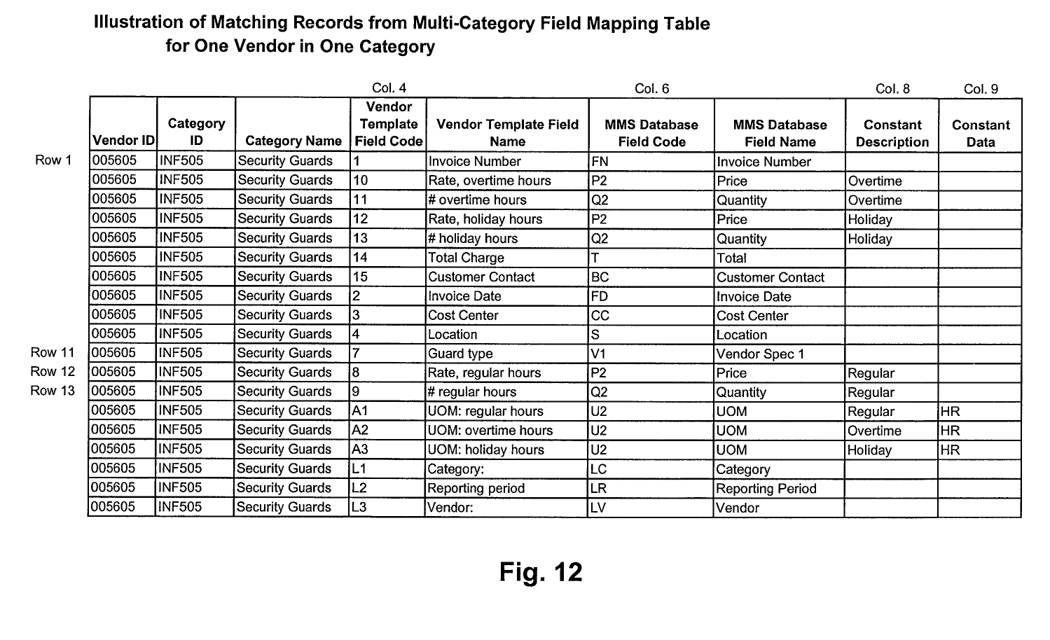

With the vendor ID retrieved from the Vendor Table and the spending category obtained from the data submission, the PDS 200 searches the Buying Entity's Multi-Category Mapping Table, of which Appendix 2 is an example, to find the set of records having a value in the “Vendor ID” column that matches the vendor ID retrieved from the Vendor Table and having a value in the “Category Name” column matching the spending category obtained from the data submission, step 2140. For the data submission example of FIG. 6, the set of records from Appendix 2 having a vendor ID of “005605” and category name “Security Guards” is shown in the table of FIG. 12.

As stated above, the PDS 200 processes a data submission one record at a time (e.g., one row of a table at a time) and each record is in turn processed one element at a time (e.g., one column at a time in a row of a table). Referring to FIG. 10B, processing of the data submission then proceeds with the first record of the data submission as the Current Record, step 2150, and the first column of the Current Records as the Current Column, step 2160. Referring briefly to the example data submission of FIG. 6, the first record here is row 6, which is the first data record of the submission and continues through row 21. The Current Column of the Current Record is first checked to see if it contains data or is blank, step 2170. If it is blank, then the next column of the Current Record is obtained, steps 2180 and 2190. If there are no more columns in the Current Record, then processing proceeds with the next record in the data submission, steps 2200 and 2210. If there are no more records in the data submission, then processing is finished.

If at step 2170 data is found in the Current Column of the Current Record, then processing continues with FIG. 10C. The Vendor Template Field Code in the Field Mapping Table indicates which column of the source data file (here, the vendor data submission of FIG. 6) is processed by which rule in the Field Mapping Table. So the set of matching records found at the Multi-Category Field Mapping Table (FIG. 12) is searched to find a record having a value in the “Vendor Template Field Code” column (column 4) that matches the column number of the Current Column. If a match is found, step 2230, then from this matching record, the value in the “MMS Database Field Code” column is retrieved, step 2240.

Here, processing begins with the Current Record and Current Column being row 6 and column 1, respectively, of FIG. 6, so from the matching records of the Multi-Category Field Mapping Table (the records shown in FIG. 12) the record of row 1 is determined to be a match since this record has a value of “1” (the column number of the Current Column being processed) in the “Vendor Template Field Code” column. Then, in step 2240, the value “FN” from the “MMS Database Field Code” column (column 6) of this record is retrieved.

It should be noted that as an alternative to searching for a match in the “Vendor Template Field Code” column, it is also possible to use the column headings of the transaction record (row 5 in FIG. 6) to index into the “Vendor Template Field Name” column of the set of matching records from the Multi-Category Field Mapping Table (see FIG. 12). This method allows columns to move or extraneous columns to be added to the data submission file without otherwise affecting the operation of the system, but has the disadvantage that the column heading on the source transaction data record must never vary.

If the chosen lookup method (column position or column name) fails to find a match, then the algorithm ignores that column of data from the input record and moves on to the next column of data (step 2180 of FIG. 10B), whereupon this lookup procedure repeats itself However, if a match is found, processing continues from step 2240 to FIG. 10D.

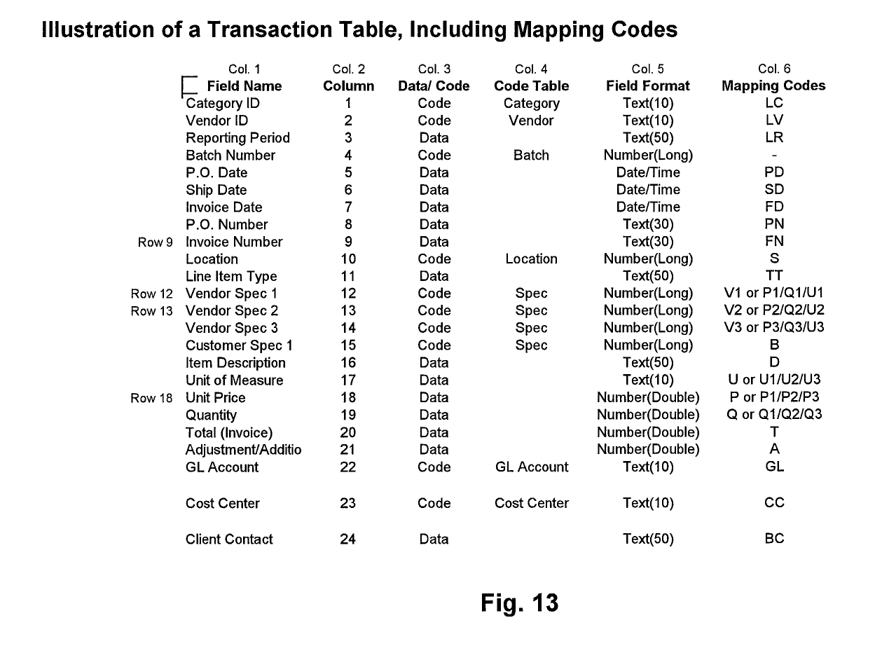

Using the MMS Database Field Code retrieved from the successful match from the set of Multi-Category Field Mapping Table records (FIG. 12), the PDS 200 goes to a table, which may be referred to as the “Transaction” Table and is shown in FIG. 13, to find the set of one or more records in the Transaction Table having a value in the “Mapping Codes” column that matches the retrieved MMS Database Field code value, step 2250. By matching the MMS Database Field Code from the lookup above to the list of Mapping Codes in the Transaction Table, the system can determine how to assign the input transaction record data field to a location in the output record (which in the system of the present invention is called the MMS Standard Transaction Format of which FIG. 9 is an example).

Here, the value “FN” previously retrieved from step 2240 is used as a key into the “Mapping Codes” column of the Transaction Table of FIG. 13 and only one record at row 9 is found to be a match. From this record at row 9, the values in the “Data/Code” and “Column” columns are retrieved, steps 2260 and 2270. Here, those values are “Data” and “9”, respectively.

At step 2280, the retrieved “Data/Code” value is checked. “Data” instructs the system to copy the input field data value directly from the transaction record of the data submission into the corresponding field (column) of the MMS Standard Transaction Format in the output record. However, as illustrated below, “Code” instructs the system to use the value of the transaction record data field as a key for a lookup into the appropriate table listed in the Code Table column of the Transaction Table.

Here, the retrieved “Data/Code” value is “data”, so processing proceeds to step 2290, where the value of the Current Column of the Current Record is retrieved. Then at step 2300, this retrieved value is stored in the corresponding record of the MMS Standard Transaction Format output record at the column having the column number that matches the “Column” value retrieved from the Transaction Table record in step 2270. As will be described further below, each record from a data submission corresponds to one or more records in a MMS Standard Transaction Format output record. As stated previously, FIGS. 9A and 9B depict a series of MMS Standard Transaction Format output records which have been converted to the MMS format from the data submission of FIG. 6. Here the record number at row 1 of the data submission of FIG. 6 corresponds to the MMS Standard Transaction Format output record at row 1 of FIG. 9B. The column entitled “Data File Line No.” (column 25) of the MMS Standard Transaction Format identifies the line of the data submission (e.g., FIG. 6) to which the record of the MMS Standard Transaction Format output record corresponds. Here, a value of “1” at column 25 of row 1 in FIG. 9B indicates that this MMS Standard Transaction Format output record corresponds to the record number “1” of the data submission. Also, as the retrieved “Column” value from the Transaction Table record is “9”, the value of “0000-00003642” retrieved from the Current Column of the Current Record is stored at column number “9” of the corresponding record of the MMS Standard Transaction Format output record, as shown at column 9, row 1 of FIG. 9A.

Returning to FIG. 10D, a check is made at step 2310 to determine if there are any more Transaction Table records in the set of Transaction Table records having a matching “Mapping Code” value and, if there is, then processing continues with the next such Transaction Table record, step 2320. Here, there are no further Transaction Table records having a “Mapping code” value of “FN” and so processing continues with step 2180 and FIG. 10B.

For columns 2 through 6 of data record number “1” (row 6) of the data submission of FIG. 6, processing continues as described above. For column 7 of this data record, processing continues as described above until step 2280. Here, at steps 2220 and 2230, the set of records from the Multi-Category Field Mapping Table (FIG. 12) is searched for a record having a “Vendor Template Field Code” value matching the Current Column number “7”. A match is found at the record of row 11 and from this record, the “MMS Database Field Code” value of “Vi” is retrieved, step 2240. From step 2250, only the record at row 12 from the Transaction Table of FIG. 13 is found to have a matching value of “VI” in the “Mapping Codes” column. Then, the values of “Code” and “12” are retrieved from this Transaction Table record's “Data/Code” and “Column” columns, respectively, step 2270. As the “Data/Code” value is “Code”, processing continues with FIG. 10E.

At step 2330, the “Code Table” value is retrieved from this Transaction Table record. At steps 2340, 2390 (FIG. 10F), and 2440 (FIG. 10G), it is checked whether the “MMS Database Field Code” value retrieved from the set of matching records (FIG. 12) is “Pn”, Qn”, and “Un” (described further below), respectively. Here the “MMS Database Field Code” retrieved is “V1” and so processing continues with FIG. 10H.

At step 2490, the value of the Current Column of the Current Record is retrieved. Here, the column number “7” of data record number “1” of the data submission (FIG. 6) is being processed, so the value retrieved from the data submission is “Guard I” (which is the value at column number 7 of data record number 1—the record at row 6). As stated above, where the “Data/Code” value retrieved from the Transaction Table record is “Code”, then a lookup into an additional table, known as a Code Table is required.

The value previously retrieved in step 2330 from the “Code Table” column of the Transaction record identifies the Code Table in which to perform the lookup. Note that there are several Code Tables in the system of the present invention: “Category Table”, “Vendor Table”, “Location Table”, “Specifications Table”, “GL Account Table”, and “Cost Center Table”. Here, the value “Spec” indicating the Specifications Table was retrieved from the Transaction Table record in Step 2330. Consequently, returning to FIG. 10H at step 2500, the PDS 200 goes to the Specifications Table and searches for a record having a value in the appropriate column matching the value retrieved from the Current Column of the Current Record, here “Guard I”.

The appropriate column searched may vary depend upon the particular Code Table identified. For example, for the Code Tables entitled “Category Table”, “Vendor Table”, “Location Table”, “Specifications Table”, “GL Account Table”, and “Cost Center Table” the corresponding appropriate columns to be searched at each table may be the “Category Name”, “Vendor Name”, “Location Name”, “Specifications Description”, “GL Description”, and “Cost Center Name” columns, respectively. Alternatively, the appropriate column may be predefined according to some logic so that particular columns need not be statically defined. For example, the appropriate column may be predefined as the second column in the identified Code Table.

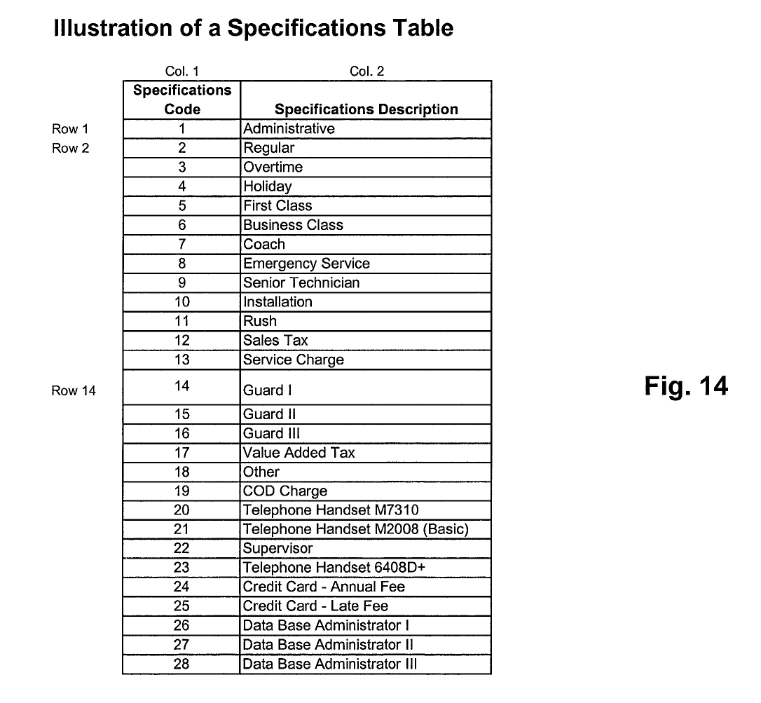

FIG. 14 is a table showing an example of a Specifications Table Code Table. The Specifications Table stores the Specification Description for each Specifications Code to identify exactly what was purchased in the transaction. The Buying Entity will generally customize the Specifications Table to correspond to its existing contracts and spending patterns. Returning to step 2500 of FIG. 10H, searching the Specifications Table for a record having a value in the “Specifications Description column (column 2) that matches “Guard I”—the value retrieved from the Current Column of the Current Record—reveals row 14 of the Specifications Table of FIG. 14 as a match. Where a match is found by searching the appropriate column of the identified Code Table, step 2510, then from this matching record the value in the relevant column is retrieved, step 2530.

The relevant column of the identified Code Table is the column of the Code Table from which information is to be extracted and stored in the MMS Standard Transaction Format output record. The relevant column may vary depend upon the particular Code Table used. For the Specifications Code table of FIG. 14, the relevant column is the column entitled “Specifications Code”, column 1. If desired, the relevant column for each Code Table may be predefined according to some logic so that particular columns need not be statically defined. For example, the relevant column may be predefined as the first column in the identified Code Table.

Returning to step 2530 of FIG. 10H, the relevant column of the Specifications Code Table is column 1 and so the value retrieved from the matching record (record 14) is “14”. Then, at step 2540, this retrieved value is stored at the corresponding MMS Standard Transaction Format output record (here, data record 1 at row 6 of FIGS. 9A and 9B) at the column number identified by the value previously retrieved from “Column” column of the Transaction Table record. Consequently, as the value “13” was retrieved from this Transaction Table record, the value of “14” retrieved from the Specifications Code Table is stored at column 13 of row 1 of FIG. 9A. Processing then continues with step 2310 of FIG. 10D. As only one Transaction Table record was previously found having a value of “VI” in the “Mapping Codes” column, processing continues with step 2180 of FIG. 110B where processing moves on to the next column of the data submission, column 8 of FIG. 6.

It should be noted that, among other things, this use of Code Tables enables the system to handle an unlimited number of different specifications for different Spending Categories (note that the length of the Specifications Table of FIG. 14 is not bounded), and yet still process them all in a consistent and economical fashion.

It should also be noted that the present invention allows for the Code Tables to be dynamically updated. Referring to FIG. 10H, as previously described the value from the Current Column of the Current Record is retrieved, step 2490, and used as an index to perform a lookup in the appropriate column at the identified Code Table, step 2500. If the relevant Code Table does not contain a match for the input value, step 2510, then system rules determine whether the input value should be added to the Code Table with a new identifier, or whether the algorithm should generate an error, step 2520.

In addition to “Data” fields and table lookup “Code” fields, there is a more complex type of field mapping required when a transaction has multiple price/quantity/unit-of-measure attributes with varying specifications. The system uses the notation Pn/Qn/Un, where n is a non-negative integer, in the Mapping Codes field of the Transaction Table to handle the processing for the multiple price/quantity/unit-of-measure Spending Categories. This situation exists in the Security Guards case shown in the data submission example of FIG. 6, as any given data input line might contain regular hours and regular rate per hour, overtime hours and overtime rate per hour, and/or holiday hours and holiday rate per hour. The Pn/Qn/Un logic is a technique which permits the disaggregation of a single line of source transaction data into multiple Price/Quantity/Unit of Measure lines for each specification in the MMS Standard Transaction Format. This technique allows the system of the present invention to analyze a potentially unlimited number of specifications at a conventional invoice sub-line item level of detail. The conversion feature has extremely high utility because data in a structure similar to that of FIGS. 9A and 9B can be readily manipulated by database techniques known in the art, whereas the same data structured as in FIG. 6 cannot be so manipulated.

It should be noted that FIGS. 9A and 9B provide only an example of MMS Standard Transaction Format output records and not all possible data configurations are shown. First, note that only two specification columns are populated: “Vendor Spec 1” and “Vendor Spec 2”. It turns out that in this simplified example (corresponding to the example data submission of FIG. 6) there are only two pricing parameters that comprise the pricing basis for security guards: guard level (Guard Level I, Guard Level II, Supervisor, etc.) and type of hours worked (regular, overtime, holiday) across each location.

The design of the MMS Standard Transaction Format allows for an arbitrarily large positive integer number n vendor specifications, as well as an arbitrarily large positive integer number m customer (or Buying Entity) specifications. This means that the MMS Standard Transaction Format is flexible enough to accommodate Spending Categories with arbitrarily large number of pricing factors. In this simplified example, the guard level was assigned to “Vendor Spec 1”, and type of hours worked for each location was assigned to “Vendor Spec 2”. (The order of the assignment is arbitrary.) Further observe that the first row of Example 6 contains the value “14” in the “Vendor Spec 1” column. The system interprets the value “14” as an index into the Specifications Code field of the Specifications Table (FIG. 14). Observe that in FIG. 14 at row 14, across from Specifications Code 14, the corresponding Specifications Description is “Guard I”. Returning to FIGS. 9A and 9B, and continuing to look down the “Vendor Spec 1” column, observe that the numbers “15” and “22” also appear in this column. Cross referencing again with the Specifications Table of FIG. 14, Specifications Code “15” indexes the “Guard II” description and Specifications Code “22” indexes the “Supervisor” description. Because there is no limit to the length of the Specifications Table, the system of the present invention can represent, and therefore analyze, a potentially unlimited number of specifications. To summarize, the design accommodates Spending Categories containing arbitrary numbers of specifications where each specification can have an arbitrary level of complexity.

The system represents location information in an analogous fashion, as the system interprets the number in the “location” column of the MMS Standard Transaction Format as an index into the Locations Table, a table of unlimited length containing all location indexes and corresponding location descriptions. Additionally, looking down the “Vendor Spec 2” column of FIGS. 9A and 9B, note that the values “2” and “3” regularly recur (in fact they regularly recur just as often as regular time hours and overtime hours recur in the transaction source data of FIG. 6), and cross-referencing again with the Specifications Table of FIG. 14, observe that “Specifications Code” index value “2” corresponds to “Regular” and “Specifications Code” index value “3” corresponds to “Overtime”.

To extend the Security Guards example further, Security Guard spending could be submitted by the vendor with a single invoice line for each guard that includes all the itemized charges for the guard's services during the time period: not just regular/overtime/holiday wage rate and hours worked as in this simplified example, but also additional fees such as insurance costs and out-of-pocket expenses. The parsing subsystem breaks that single invoice line into as arbitrarily many MMS Standard Transaction Format lines as necessary to completely disaggregate the price, quantity, and total cost of each pricing component of the guard's services: straight time, overtime, holiday time, health insurance, mileage expenses, etc. Disaggregating the data in this fashion makes it possible to analyze costs across however many spending dimensions are relevant for each Spending Category.

The processing of Pn/Qn/Un codes and the disaggregation of multiple pricing components may be illustrated with continued reference to the example data submission of FIG. 6. Processing column 8 as the Current Column of the first data record (row 6) as the Current Record of FIG. 6, data is found, step 2170, and processing continues with FIG. 10C. Searching the set of matching records of the Multi-Category Field Mapping Table (FIG. 12), row 12 is identified as having a value in the “Vendor Template Field Code” column matching the Current Column number of “8”, step 2220. The value of “P2” is then retrieved from the “MMS Database Field Code” column of this record, step 2240.

From the Transaction Table of FIG. 13, two records—at rows 13 and 18—are found having matching values of “P2” in the “Mapping Codes” column, step 2250. Beginning with the first matching Transaction Table record at row 13 as the Current Matching Transaction Table record, step 2260, the values of “Code” and “13” are retrieved from the “Data/Code” and “Column” columns, respectively, step 2270. Since the value of “Code” is retrieved, step 2280, processing continues with FIG. 10E where the value of “Spec” is retrieved from the Current Matching Transaction Table record, step 2330. As the value “Pn” was the “MMS Database Field Code” value retrieved from the matching record from the set of Multi-Category Field Mapping Table records (FIG. 12), processing continues from step 2340 to step 2350.

When processing the Pn/Qn/Un codes, the MMS system looks in the Constant Description column of the Field Mapping Table to find out the value of the given specification attribute (in this case, specification 2) for the Price or Quantity in the input field. Consequently, at step 2350, the value from the “Constant Description” column is retrieved from the matching record from the set of Multi-Category Field Mapping Table records of FIG. 12. Here, the value retrieved from row 12 is “Regular”. Since “Spec” was the “Code Table” value previously retrieved at step 2330, the PDS 200 goes to the Specifications Code Table (FIG. 14) to find a record having a value of “Regular” in the “Specifications Description” column, step 2360. Row 2 is found as a match and the value of “2” from the “Specifications Code” of this record is retrieved, step 2370. As the value of “13” was previously retrieved from the “Column” column of the Current Matching Transaction Table record, the value of “2” retrieved from the Specifications Code Table is stored at column 13 of the corresponding MMS Standard Transaction Format output record shown in FIGS. 9A and 9B. Processing then continues with FIG. 10D and the next matching Transaction Table record, which is the record at row 18 of the Transaction Table of FIG. 13, steps 2310 and 2320.

From this record, the values of “Data” and “18” are retrieved from the “Data/Code” and “Column” columns, respectively, step 2270. Since the value of “Data” was retrieved, step 2280, processing continues with step 2290 where the value of “5.20” is retrieved from the Current Column of the Current record. This value is then stored at column 18 of the corresponding MMS Standard Transaction Format output record shown in FIGS. 9A and 9B. Processing then continues in a similar manner as described above for the remaining columns 9 through 15 of the data record number 1 (row 6) of the example data submission of FIG. 6 (note that columns 10 and 11 for “Overtime Hourly Rate” and “Overtime Hours” are not processed as no overtime hours were submitted for this data record).

The disaggregation of multiple pricing components may be illustrated with data record number 2 (row 7) of the example data submission of FIG. 6. Note that with data record number 1 of the data submission, there is only a single set of price/quantity/unit-of-measure attributes—an hourly rate of $5.20 for 35 hours. Referring FIGS. 9A and 9B, it can be seen that data record 1 of the data submission of FIG. 6 was translated to a single MMS Transaction Format output record at row 1. However, as shown by column 25 of rows 2 and 3, both of these output record rows of FIGS. 9A and 9B correspond to data record 2 of the data submission of FIG. 6. This is due to the fact that data record 2 of the data submission has two sets of price/quantity/unit-of-measure attributes—a regularly hourly rate of $5.20 and regular hours of 40 and an overtime hourly rate of $7.80 and 14.5 overtime hours—and each set of price/quantity/unit-of-measure attributes has been disaggregated into separate lines in the MMS Transaction Format output record. Referring to FIGS. 9A and 9B, it can be seen that row 2 corresponds to the regular hourly rate and regular hours information while row 2 corresponds to the overtime hourly rate and overtime hours information.

An additional feature of the system of the present invention is represented by the An Field Mapping Code, used in FIG. 12 for the U2 fields. The An code indicates that the data for this database field is found not in the input data, but in the Constant Data column of the Field Mapping Table itself. In this example, the Al Vendor Template Field Code in the Field Mapping Table records instructs the system that the Unit of Measure value in the MMS transaction data is “HR” (hours) when the specification 2 value is Regular. The A2 and A3 lines in the example do the same for Overtime and Holiday. (Note that only the “A” is relevant in these codes; the “1”, “2”, and “3” are merely for uniqueness.) This feature allows constant data to be defined in the system itself rather than expecting it as part of the data submission.

If the vendor data file is successfully parsed, the system of the present invention updates the Process Control Table to reflect that the data set is ready for storage at the MMS Database. If parsing fails, the system notifies an operator for intervention. If parsing is successful, then rather than storing the translated data at the MMS database, if desired, processing may continue with the Verify and Commit Data Subsystem.

Verify and Commit Data Subsystems

The Verify and Commit Data Subsystem (VCDS)600, ensures the validity and compatibility of the data set before storing it in the MMS database.

If the optional VCDS 600 has been implemented in the MM system, the PDS 200 sends the data set that has been translated to the MMS Standard Transaction Format to the VCDS 600 to compare the data of the initially received data submission (now in MMS Standard Transaction Format), e.g., vendor supplied data as in FIG. 6, against other data received for the same transaction(s) as represented by the initially received data submission, e.g., the totals submitted as part of the vendor invoice. The MMS compares totals by invoice number as well as by invoice line item.

One way in which this comparison is performed is by the system displaying invoice numbers and totals, with basic drilldown by invoice number and line number, to facilitate manual comparison with invoices. An operator approves or rejects the comparisons. Other verification checks performed may include: identifying missing transaction details from invoices, identifying missing invoices, comparing vendor-provided totals to the invoice totals, and comparing vendor-provided data for a particular transaction to the expected price for transaction as calculated by utilizing all known pricing contracts available to the organization including any PUBLIC RATECARD or PRIVATE RATECARD system as well as any paper contracts. The system of the present invention also contains a subsystem to correct certain common errors made by vendors regarding price and quantity for items which are effectively one unit per invoice (such as Tax or Shipping).

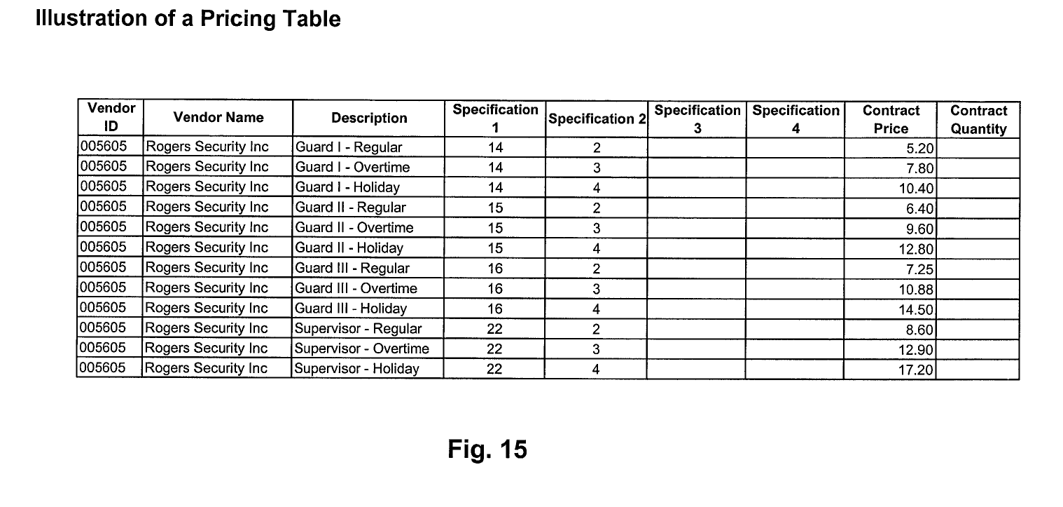

To perform contract compliance, the parsed and mapped transaction data is compared to the Pricing Table, an example of which is shown in FIG. 15. The Pricing Table allows the operator to view vendor contracts broken down by specification and price. For illustration purposes, the Pricing Table of FIG. 15 shows only information for one vendor and one spending category, but it should be noted that information related to any number of vendors and spending categories may be represented. Here, the Pricing Table of FIG. 15 shows how the Buying Entity's contracted price for regular, overtime and holiday pay for security guards from a particular vendor is represented in the system.

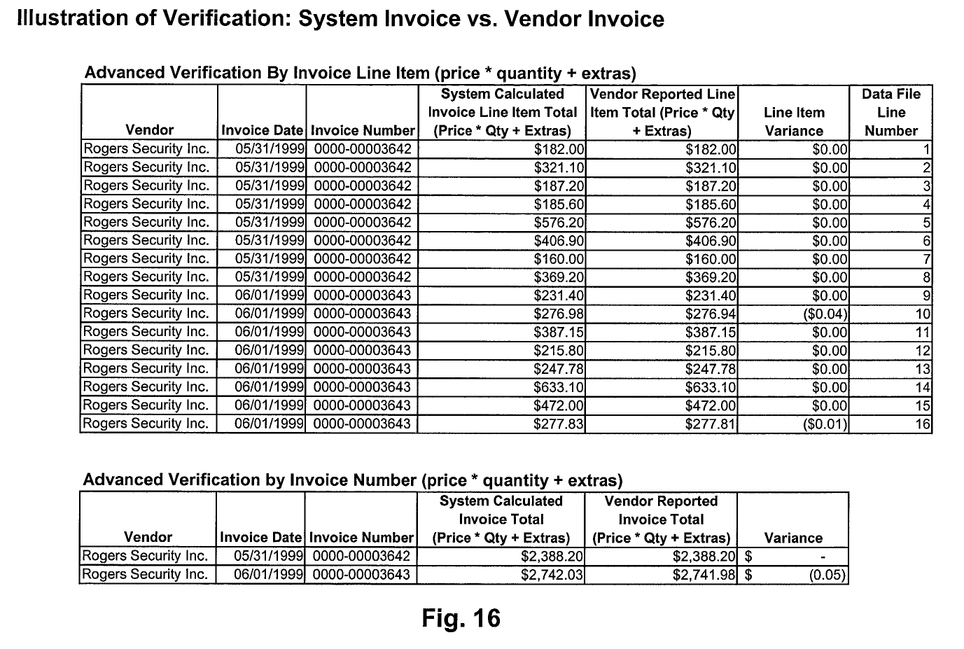

The system then calculates the mathematical difference between the contract price as represented in the Pricing Table and the actual price paid from the transaction data submission received by the system at the IDS 100. FIG. 16 is a table that provides an example of a mapping of the price deviation based on the system's calculations and the total deviation based on the price deviation multiplied by the quantity of the transaction. FIG. 16 clearly lays out the discrepancies between expected and actual expenditure within specific vendor contracts.

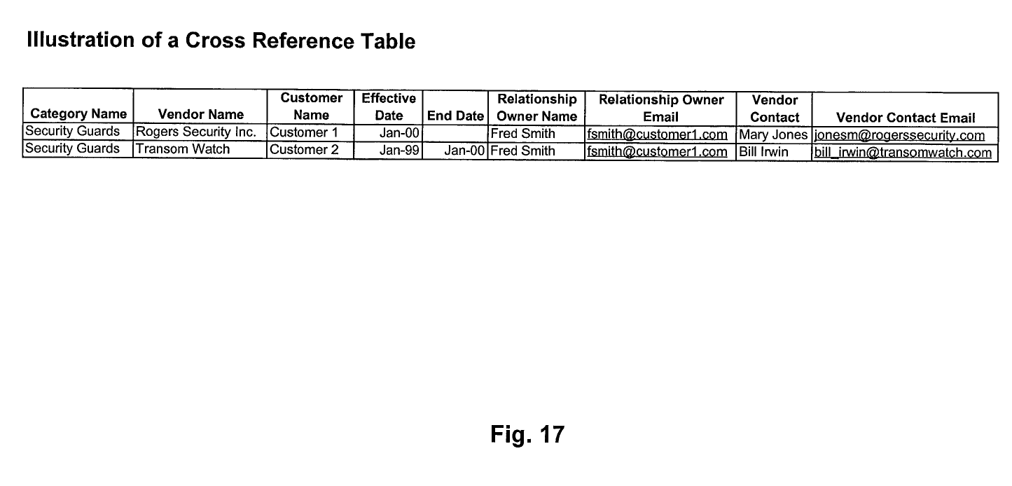

Similarly, a Cross Reference Table, an example of which is shown in the table of FIG. 17, contains information on a Buyer Entity/vendor/commodity grouping, such as the active dates of the relationship and the responsible parties. If errors are found in a vendor data submission, the MM system emails both parties indicating the problem. The operator may also perform offline reconciliation with the supplier of the data.

After verification, the system commits the verified and translated data outputs to the MMS Database which acts as a data repository. The system assigns tracking numbers to approved data sets that identify both the person doing the commit and the original source of data.

If the data file is successfully committed to the MMS Database, the system updates the Process Control Table to reflect that the data set is ready for the Extract and Calculate Data Subsystem.

Extract and Calculate Data Subsystems

At any time after the transaction data has been stored in the MMS database (by either the PDS 200 or the VCDS 600), The system may trigger the Extract and Calculate Data Subsystem (ECDS) 400. The ECDS 400 may be triggered in any manner desired, such as, for example, on a scheduled basis or at the operator's discretion. The system runs all previously defined queries, but also provides the operator with a custom query option. If a custom query is needed, the operator defines a new query via the Internet or a workstation. If a modified query is needed, the operator selects a query and changes it according to the required result. All custom queries are stored in the MMS Database for future use. The operator then runs all defined queries, including the custom queries, so that the system can perform predefined calculations on the query outputs. Query and Calculation results are stored in the MMS Database, ready for retrieval by the MMS Reporting Subsystem 500. If the calculated data is successfully committed to the MMS Database, the Process Control Table is updated to reflect that the data set is ready for the Reporting Subsystem.

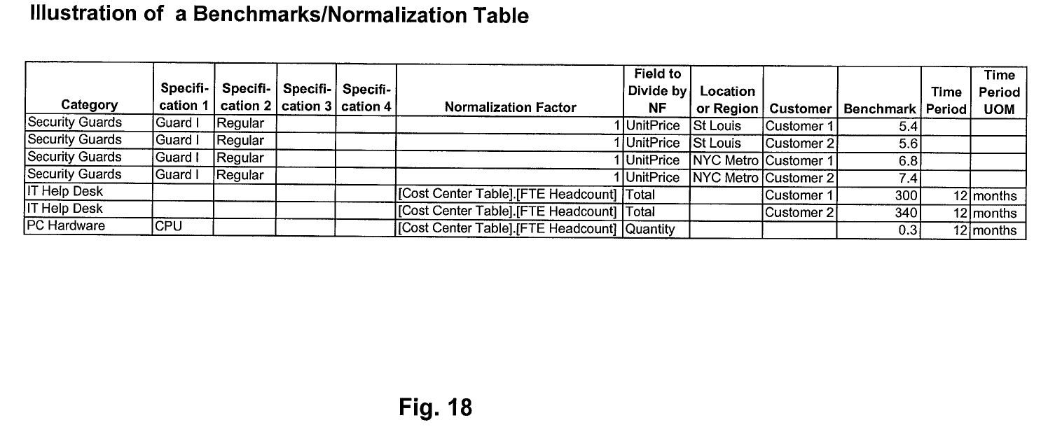

The MMS may use a Benchmarks/Normalization Table to facilitate the creation of managerially relevant reporting and data comparisons. An example of a Benchmarks/Normalization Table is shown in FIG. 18. In this example, the system operator keys benchmarks into the table for security guard hourly wage unit pricing by Category Specification in two different locations (cities, in the example), for two different buying organizations. There are two broad types of benchmarks, internal benchmarks and external benchmarks; the system of the present invention accommodates both kinds of benchmarks. An internal benchmark is a standard set for performance measurement inside of a Buying Entity without reference to any industry benchmark information, whereas an external benchmark could be obtained from a variety of resources available to procurement managers, such as industry associations, trade associations, and private benchmarking studies.

The Benchmarks/Normalization Table enables the system of the present invention to report on pricing trends for any Spending Category (such as security guards) for which benchmarks exist, and normalize for the fact that the performance benchmark for, say, pricing will vary by geographic region and by the size of the buying organization, due to negotiating leverage.

The technology examples (IT Help Desk and PCs) show how benchmarks can also be provided for computed metrics, in this case Total Spending or Quantity Purchased divided by number of employees (FTEs) per Cost Center over any time frame. This capability is useful for spending categories where spending efficiency is not measured so much by the raw pricing or spending numbers, but instead by the relationship of those numbers to other organizational attributes such as number of employees (FTEs) or the square footage of a facility. In particular, these types of normalizations can be helpful for demand management tracking, such as measuring how many PCs a Buying Entity purchases per employee per unit of time.

Note that the Benchmarks/Normalization Table and its operation may include a “wild card” feature. For example, a “wild card” benchmark is a benchmark that applies to all specifications for a category. In the example of FIG. 18, a blank field in the “Specification 1” column indicates a wild card benchmark for the category “IT Help Desk”. Similarly, a blank field in the “Location or Region” column would represent a wild card that would apply to all locations or regions for the category and specifications that have been defined in that row of the table.

In addition, the Benchmarks/Normalization Table and its operation may include the ability to store pointers for table values rather than the values themselves. For example, in the normalization factor column above, the notation “[Cost Center Table].[FTE Headcount] is a pointer to the FTE headcount field of the Cost Center Table. Note that a Total benchmark is a benchmark for all of the dollar spending in one category or specification at one customer (e.g., dollars per FTE per time interval). A quantity benchmark is a benchmark for the units purchased in a given category or specification (e.g., units per FTE per time interval). A time interval must be specified for Total and Quantity benchmarks, otherwise the benchmark cannot be defined. However, the invention is flexible enough to allow for multiple varying time periods and units of measure (“UOM”) such as months, days, years, or any other desired increment of time. In this example, a Total benchmark is represented by the word “Total” in the “Field to Divide by NF” column. Similarly, a Quantity benchmark is represented by the word “Quantity” in the “Field to Divide by NF” column.

Once data has been extracted and calculations have been performed, the MM system may update the Process Control Table to indicate that the data and calculations are ready for reporting.

Reporting Subsystem

The Reporting Subsystem 500 may be implemented utilizing tools known in the art. For example, a Reporting Subsystem could be implemented using a generic OLAP (on-line analytical processing) product, such as, for example, HYPERION ESSBASE, along with report writing tools, such as ALPHABLOX.

The reporting subsystem queries the MMS system tables and creates standard or custom reports for company management, buyers, vendors, and any other constituencies on a scheduled basis or on demand. Any type of report may be generated, including, for example, tabular, graphical, and text reports for procurement management and for vendors. In creating reports, the Reporting Subsystem 500 may access one or all of the following: MMS Standard Transaction Format output records for transaction data, Inventory Status Tables for inventory information, Field Mapping Tables to obtain data labels, a Rules Table which describes internal processing, Metrics Tables which retain relevant calculations for each category, and the Coding Tables described previously.

It should be noted that the reports generated by the Reporting Subsystem facilitate cross-category comparisons. Also, report development time is reduced because reporting formats are shared within the Reporting Subsystem.

Also using techniques known in the art, security features can be added to the viewing of the reports so as to ensure that only authorized users can view authorized reports. The security of multiple users' datasets is maintained. In addition, techniques known in the art can be employed to enable viewing of the reports over Local Area Network(s) or the Internet.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer implemented method for processing data representing transactions involving a plurality of commodities and one or more suppliers for each of the plurality of commodities, the method comprising:
receiving data representing a transaction involving one of the plurality of commodities, the data having a format and including a price, a quantity, two or more characteristics of the commodity involved in the transaction, and the identity of the supplier of the commodity involved in the transaction;
translating the data from the format in which it was received into an internal format, where the internal format allows for the price, the quantity, each of the commodity characteristics, and the supplier identity of the data representing the transaction to be directly accessed; and
storing the translated data.

2. The method of claim 1, where the data representing the transaction is received as two or more data submissions.

3. The method of claim 2, where the two or more data submissions are received from two or more data sources.

4. The method of claim 1, further comprising validating that the received data conforms to an external format and proceeding to the step of translating if the received data is so validated.

5. The method of claim 1, where the format in which the data is received is one of one or more external formats, and where the step of translating comprises:
modifying the data from the external format in which it was received to one of a plurality of intermediary formats, where each of the plurality of intermediary formats is related to one of the plurality of commodities, and where the intermediary format into which the received data is modified is related to the commodity involved in the transaction; and
changing the data from the intermediary format into which it was modified to the internal format,
where the internal format is the same for each of the plurality of commodities and for each of the one or more suppliers for each commodity.

6. The method of claim 5, where each of the one or more external formats is associated with a set of external format rules, where each set of external format rules relates the external format with which it is associated to each of the plurality of intermediary formats; and
where the set of external format rules associated with the external format in which the data was received is used to modify the data from the external format in which it was received to the one of a plurality of intermediary formats.

7. The method of claim 5, where each of the plurality of intermediary formats is associated with a set of intermediary format rules, where each set of intermediary format rules relates the intermediary format with which it is associated to the internal format; and
where the set of intermediary format rules associated with the intermediary format into which the received data was modified is used to change the data from the intermediary format into which it was modified into the internal format.

8. The method of claim 7, where each set of intermediary format rules is stored in a relational database.

9. The method of claim 5, where the one or more external formats includes an electronic spreadsheet format.

10. The method of claim 5, where the one or more external formats includes a text file format.

11. The method of claim 5, where the one or more external formats includes a paper document format.

12. The method of claim 5, where the data is received from an external computer system; and
where the one or more external format includes a format in which the external computer system transmits data.

13. The method of claim 12, where the external computer system is an electronic procurement system.

14. The method of claim 12, where the external computer system is an accounts payable system.

15. The method of claim 12, where the external computer system is a requisition system.

16. The method of claim 12, where the external computer system is a purchase order system.

17. The method of claim 12, where the external computer system is a supplier billing system.

18. The method of claim 12, where the external computer system is a procurement marketplace system.

19. The method of claim 12, where the external computer system is a private ratecard system.

20. The method of claim 12, where the external computer system is a public ratecard system.

21. The method of claim 1, further comprising verifying the translated data against other data representing the transaction and proceeding to the storing if the translated data is verified against the other data.

22. The method of claim 5, where the translated data is stored in a database.

23. The method of claim 22, where the database is relational.

24. The method of claim 23, where the method further comprises:
extracting data from the database; and
processing the extracted data.

25. The method of claim 24, where the data is extracted according to the internal format.

26. The method of claim 24, where the extracted data is extracted in response to a query.

27. The method of claim 24, further comprising generating reports based on the processed data.

28. The method of claim 1, where the external format in which the data is received is one of one or more external formats;
where the internal format into which the data is translated is one of a plurality of internal formats, where each of the internal formats allows for the price, the quantity, each of the commodity characteristics, and the supplier identity of the data representing the transaction to be directly accessed, and where each of the plurality of internal formats is related to one of the plurality of commodities, and where the step of translating comprises:
modifying the data from the one of the one or more external formats in which it was received to one of the plurality of internal formats;
where the internal format into which the data is modified is related to the commodity involved in the transaction.

29. The method of claim 28, where the translated data is stored in a database.

30. The method of claim 29, where the database is relational.

31. The method of claim 30, where the method further comprises:
extracting data from the database; and
processing the extracted data.

32. The method of claim 31, where the data is extracted according to one of the plurality of the internal formats.

33. The method of claim 31, where the extracted data is extracted in response to a query.

34. The method of claim 31, further comprising generating reports based on the processed data.

35. A computer system for processing data representing transactions involving a plurality of commodities and one or more suppliers for each of the plurality of commodities, the system comprising:
a data input interface that receives data representing a transaction involving one of the plurality of commodities, the data having a format and including a price, a quantity, two or more characteristics of the commodity involved in the transaction, and the identity of the supplier of the commodity involved in the transaction;
a database; and
a data processor in communication with the data input interface and the database;
where the data processor translates the data received at the data input interface from the format in which the data was received into an internal format, where the internal format allows for the price, the quantity, each of the commodity characteristics, and the supplier identity of the data representing the transaction to be directly accessed; and
where the data processor outputs the translated data to the database.

36. The system of claim 35, where the database is relational.

37. The system of claim 35, further comprising:
a second data processor in communication with the database;
where the second data processor extracts data from the database and processes the extracted data.

38. The system of claim 37, where second data processor extracts data from the database according to the internal format.

39. The system of claim 37, where the second data processor receives a data query and extracts data from the database in response to the data query.

40. The system of claim 37, further comprising:
a third data processor in communication with the second data processor;
where the second data processor outputs the processed data to the third data processor; and
where the third data processor generates reports based on the processed data received from the second data processor.

41. A computer system for processing data representing transactions involving a plurality of commodities and one or more suppliers for each of the plurality of commodities, the system comprising:
a data input interface that receives data representing a transaction involving one of the plurality of commodities, the data having a format and including a price, a quantity, two or more characteristics of the commodity involved in the transaction, and the identity of the supplier of the commodity involved in the transaction;
a database;
a first data processor in communication with the data input interface;
a second data processor in communication with the first data processor and the database;
a third data processor in communication with the database; and
a fourth data processor in communication with the third data processor;
where the first data processor translates the data received at the data input interface from the format in which the data was received into an internal format, where the internal format allows for the price, the quantity, each of the commodity characteristics, and the supplier identity of the data representing the transaction to be directly accessed;
where the first data processor outputs the translated data to the second data processor;
where the second data processor receives other data representing the transaction, allows the translated data received from the first data processor to be verified against the other IS data received, and stores the translated data in the database if the verification is successful;
where the third data processor extracts data from the database, processes the extracted data, and outputs the processed data to the fourth data processor; and
where the fourth data processor generates reports based on the processed data received from the third data processor.

42. A computer program product comprising a computer usable medium having computer readable code embodied therein, the computer readable code, when executed, causing a computer to implement a method for processing data representing transactions involving a plurality of commodities and one or more suppliers for each of the plurality of commodities, the method comprising:
receiving data representing a transaction involving one of the plurality of commodities, the data having a format and including a price, a quantity, two or more characteristics of the commodity involved in the transaction, and the identity of the supplier of the commodity involved in the transaction;
translating the data from the format in which it was received into an internal format, where the internal format allows for the price, the quantity, each of the commodity characteristics, and the supplier identity of the data representing the transaction to be directly accessed; and
storing the translated data.

43. The computer program product of claim 42, where the format in which the data is received is one of one or more external formats, and where the step of translating comprises:
modifying the data from the external format in which it was received to one of a plurality of intermediary formats, where each of the plurality of intermediary formats is related to one of the plurality of commodities, and where the intermediary format into which the received data is modified is related to the commodity involved in the transaction; and
changing the data from the intermediary format into which it was modified to the internal format,
where the internal format is the same for each of the plurality of commodities and for each of the one or more suppliers for each commodity.

44. The computer program product of claim 43, where each of the one or more external formats is associated with a set of external format rules, where each set of external format rules relates the external format with which it is associated to each of the plurality of intermediary formats; and
where the set of external format rules associated with the external format in which the data was received is used to modify the data from the external format in which it was received to the one of a plurality of intermediary formats.

45. The computer program product of claim 43, where each of the plurality of intermediary formats is associated with a set of intermediary format rules, where each set of intermediary format rules relates the intermediary format with which it is associated to the internal format; and
where the set of intermediary format rules associated with the intermediary format into which the received data was modified is used to change the data from the intermediary format into which it was modified into the internal format.

46. The computer program product of claim 42, where the implemented method further comprises verifying the translated data against other data representing the transaction and proceeding to the storing if the translated data is verified against the other data.

47. The computer program product of claim 43, where the translated data is stored in a database.

48. The computer program product of claim 47, where the implemented method further comprises:
extracting data from the database; and
processing the extracted data.

49. The computer program product of claim 48, where the data is extracted according to the internal format.

50. The computer program product of claim 48, where the data is extracted in response to a query.

51. The computer program product of claim 48, where the implemented method further comprises generating reports based on the processed data.

52. A computer implemented method for processing data representing transactions involving a plurality of commodities and one or more suppliers for each of the plurality of commodities, the method comprising:
receiving data representing a transaction involving one of the plurality of commodities, the data having a format and including a price, a quantity, two or more characteristics of the commodity involved in the transaction, and the identity of the supplier of the commodity involved in the transaction;
translating the data from the format in which it was received into an internal format, where the internal format allows for the price, the quantity, each of the commodity characteristics, and the supplier identity of the data representing the transaction to be directly accessed; and
storing the translated data for later processing by a data processing system.
